(19) United States
(12) Patent Application Publication
(10) Pub. No.: US 2001/0034011 A1
(43) Pub. Date: Oct. 25, 2001

(54) System for aiding the selection of personnel

(76) Inventor: Lisa Bouchard, Rochester, NY (US)

Correspondence Address: BROWN PINNISI & MICHAELS, 400 M & T BANK BUILDING, 118 NORTH TIOGA ST, ITHACA, NY, 14850

(21) Appl. No.: 09/766,346

(22) Filed: Jan. 19, 2001

Related U.S. Application Data
(60) Provisional application No. 60/181,262, filed on Feb. 9, 2000.

(51) Int. Cl. G09B 19/00

(52) U.S. Cl. 434/236

(57) ABSTRACT

A method of analyzing the fitness of a candidate for a specific position comprises benchmarking the position by specifying weighted position criteria and using managers' and top performers' responses to predictive instruments in the form of behavior and values questionnaires; scoring the candidate by computing a weighted average of the candidate's scores on the position criteria combined with the candidate's predictive instrument scores vis a vis those of the benchmark participants; and reporting to the hiring manager the candidate's overall score and, preferably, individual scores for each continuum of the predictive instruments. In the preferred embodiment, the method also entails providing a database of characteristics associated with various ranges of scores on the predictive instruments' continua, together with potentially problematic motivations or behaviors likely to be exhibited by a candidate scoring well below or above the benchmark participants for each continuum, and suggested follow-up interview questions. All such information is preferably included in the same report to the hiring manager that contains the candidate's overall score and predictive-instrument continuum scores.

### REFERENCE TO RELATED APPLICATIONS

This application claims an invention which was disclosed in Provisional Application No. 60/181,262, filed Feb. 9, 2000, entitled “Vital workforce business method”. The benefit under 35 USC §119(e) of the United States provision application is hereby claimed, and the aforementioned application is hereby incorporated herein by reference.

### BACKGROUND OF THE INVENTION

1. Field of the Invention

The invention pertains to the field of selecting personnel by predicting the performance of candidates for employment. More particularly, the invention pertains to aiding hiring decisions by using measurements of behavioral and motivational characteristics of employment candidates to predict their performance.

2. Description of Related Art

Many corporations have found that the need to reduce costs often means their workforce must become smaller. Additionally, increases in mobility have led to a higher level of personnel turnover in many organizations. While these changes take place, the same corporations have been expected to consistently increase the quantity and quality of the goods or services they provide, and charge less for the same. Accordingly, balancing the competing demands of various stakeholders—shareholders, customers, employees, and others—has become one of the primary challenges facing many senior management teams in the modem global economy.

Manifestly, it is difficult to successfully balance such demands without hiring and retaining individuals who are well suited for the particular positions in which they work (hereinafter, a “vital workforce”). Attaining and retaining a vital work force maximizes the probability that an organization's personnel will perform well and exhibit low turnover. It is thus crucial that a business organization's hiring representative make sound hiring decisions. An organization's hiring representative, however, typically makes many decisions based upon intuition and subjectivity rather than fact, proven successes and objective information. Such subjective, ad-hoc practices result in a far lower than optimal rate of success in achieving a vital workforce. The reason is that the accuracy of predicting how well a given person will perform a job based solely on traditional subjective and/or ad-hoc factors—such as information gleaned from a resume and a personal interview—is quite low. Accordingly, the hiring managers of business organizations need a systematic way of improving their success rate in attaining a vital workforce. Such can be achieved through an increased ability to predict the likelihood of success of a given individual in a particular job or task, in a particular job environment.

One way to improve a hiring manager's decision-making process is to remove much of the subjectivity ordinarily inhering in that process, and replace it with objective criteria. One attempt at establishing control over hiring decisions based upon objective criteria is provided by the invention by Bonnstetter et al., disclosed in U.S. Pat. 5,551,880, EMPLOYEE SUCCESS PREDICTION SYSTEM (hereinafter, the “Bonnstetter patent”). That invention teaches a method of aiding a decision whether to hire a particular individual for a specific position by analyzing behavioral and value traits of that individual as a means of predicting whether such individual will perform well in the job and the job environment. Behavioral traits are aspects of one's behavioral styles and habits. Value traits are those interests, goals and preferences which guide one's life and career and motivate one to sacrifice rest, leisure or other pursuits in order to accomplish a particular task. The behavior and value traits are derived and measured through use of questionnaires which constitute predictive instruments. These results are compared with known national standards, and are reported out to the decision-maker, preferably through the use of computer software.

Another approach is provided by the invention by Ostby, et al., disclosed in U.S. Pat. No. 5,326,270, SYSTEM AND METHOD FOR ASSESSING AN INDIVIDUAL'S TASK-PROCESSING STYLE. That invention discloses a means of evaluating a person's style of problem solving by requiring him or her to respond to simulated emergencies or other scenarios displayed upon a computer screen. The computer records the manner and quickness in which the individual assesses available resources and uses those resources to decide upon and provide resolution for the simulated scenarios. Such data are then statistically analyzed in an effort to evaluate how well the person is suited for a particular position available within the organization.

Use of objective information attainable through methods such as those disclosed in the above-referenced patents has some value in aiding the hiring selection process. A more complete evaluation of a person's likelihood to perform well at a particular job, however, must take into account additional factors. For one, traditional factors such as education, experience, and background reference checks—factors which cannot be measured through psychological questionnaires or computer-simulated scenarios—must be taken into account and weighted appropriately, as a supplement to the objective, testable factors. This may be particularly important to comply with legal requirements such as those enforced by the Equal Employment Opportunity Commission. In particular, use of a system in which the results of behavioral and values questionnaires account for more than 50% of a candidate's predictive score may run afoul of certain regulations.

Additionally, to the extent objective, testable factors are utilized, as derived from predictive instruments, the manner of such utilization must avoid preconceived notions of the characteristics of a good performer in a particular position, such as the notion that salespersons must be extroverted, or accountants must be introverted. Such type-casting is known to be flawed and, moreover, fails to account for the behavioral style and motivational traits that are, in practice, known to be associated with a high degree of adaptability to a given position in a highly specific job environment. A more accurate manner of utilizing objective, testable factors, therefore, is to compare the applicant's scores with those of known good performers in the position for which the individual is a candidate. Finally, a system for aiding a hiring manager to determine whether a particular candidate may be successful in a specific position should ideally identify the types of questions that can be asked at a follow-up interview of the candidate, after the statistical analysis has been performed and reported out. In this manner a hiring manager can more easily assess whether the candidate is trainable where there is a risk of low performance.

It is clear from the foregoing that there is a need for a method and system to predict the success of a job applicant which utilizes a combination of traditional factors and the results of predictive instruments, and which measures the applicant's scores on the predictive instruments against those of persons who are known to be good performers in the position for which the applicant is being considered.

### SUMMARY OF THE INVENTION

The present invention discloses a method of analyzing the fitness of an individual for a particular position of employment. An individual's fitness is defined as his or her likelihood of exhibiting high job performance and job longevity. Accordingly, use of the invented method enables a hiring representative within a business organization to make high quality hiring decisions, that is, decisions that are likely to result in a highly-effective workforce with low turnover.

The invented method combines utilizing traditional means of evaluating a job applicant, such as evaluating information derived from the applicant's resume and personal interviews, with other evaluation means, namely, measuring and analyzing the individual's behavioral style and motivational characteristics. Such measurement and analysis includes comparing the data regarding the applicant's behavioral style and motivational characteristics with that of known top performers or achievers in the position and job environment for which the individual is being considered.

The invented method removes the majority of the subjectivity involved in making hiring decisions through creation of a positional benchmark. This is accomplished through utilization of position criteria based upon traditional factors as well as predictive instruments, to create standard ranges for the components involved in the process. These components in combination are termed the positional benchmark. The benchmark may then be used as the standard for the position requirements.

In a preferred embodiment, the predictive instruments involved in the creation of the candidate's norm-referenced measurement score are the DISC (dominance-influence-steadiness-compliance) personal profile and the PIAV (personal interests, attitudes and values) profile. Additionally, the norm-referenced measure calls for the position criteria that are chosen and weighted according to their importance in the position. A bivariate correlation coefficient is then used to show the relationship between the benchmark and the norm-referenced measure derived from the candidate's information. By utilizing this comparison, an organization can increase the predictability of success or likelihood of risk of a prospective new hire.

Referring to FIG. 1, the high-level process steps of the invented method are: benchmarking the position for which the candidate is being considered; finding a candidate and obtaining and recording his or her DISC responses, PIAV responses and positional-criteria scores; deriving a calculation summary (hereinafter, a “Candidate Recommendation”); generating a report of the DISC and PIAV responses, the positional criteria scores and the Candidate Recommendation; and conducting a follow-up interview if one is indicated, which includes asking the questions suggested on the report. If an interview was not needed, the reason is that the candidate clearly was or was not a match for the position. The decision of whether to hire the candidate is made based upon the Candidate Recommendation and the interview, if one was conducted.

Preferably, the Candidate's score on the DISC and PIAV predictive instruments each constitute twenty percent of the Candidate Recommendation and the Candidate's score relative to the Position Criteria constitutes sixty percent of the Candidate Recommendation. Each position criterion is chosen and weighted in proportion to the relevance of importance in the position. Such criteria can include, without limitation: education, experience, skill level, product or industry knowledge, phone screen/application, general behavior-based interview, competency-based interview, behavioral gap interview, realistic job preview, and reference, background and customer checks.

A system according to the invented method generates a bivariate correlation coefficient score that shows the magnitude of the relationship between the candidate and the established benchmark of the position. This correlation suggests the candidate's probability of success or risk in a position. The correlation score does not make the hiring decision for the hiring manager. Rather, it gives the hiring manager a balanced view of an applicant through consideration of all the elements needed by an applicant to be successful in the position in question. If the score is in a middle range that does not strongly predict either success or failure of the candidate, a further optional step comprises evaluating whether there are weak behavioral factors measured by the behavioral predictive instrument which can be altered through training or coaching in such manner that the candidate would perform well after receiving such training or coaching.

### BRIEF DESCRIPTION OF THE DRAWINGS

FIG. 1 shows a flow chart of the steps of the method according to the present invention.

FIG. 2A shows, as part of a report according to the invented method, a candidate scoring form including the candidate's overall score, position criteria scores, and raw DISC and PIAV scores.

FIG. 2B shows, as part of a report according to the invented method, green, red and yellow zones of the four DISC continua, and a candidate's scores for each continuum.

FIG. 2C shows, as part of a report according to the invented method, flags, potentially problematic behaviors, and interview questions for a candidate relative to the DISC continua of D and I.

FIG. 2D shows, as part of a report according to the invented method, flags, potentially problematic behaviors, and interview questions for a candidate relative to the DISC continua of S and C.

FIG. 2E shows, as part of a report according to the invented method, green, red and yellow zones of the six PIAV continua, and a candidate's scores for each continuum.

FIG. 2F shows, as part of a report according to the invented method, flags, potentially problematic motivations, and interview questions for a candidate relative to the PIAV continua of Th, U, and A.

FIG. 2G shows, as part of a report according to the invented method, flags, potentially problematic motivations, and interview questions for a candidate relative to the PIAV continua of S, I, and Tr.

FIG. 2H shows, as part of a report according to the invented method, green, red and yellow zones of the selected position criteria, and a candidate's scores for each criterion.

FIG. 3 shows a work environment DISC profile according to the prior art.

FIG. 4 shows a behavioral style DISC questionnaire according to the prior art.

FIG. 5 shows behavioral style DISC “most” and “least” analysis graphs according to the prior art.

FIG. 6 shows a Personal Interests, Attitudes and Values (PIAV) questionnaire according to the prior art.

FIG. 7A shows DISC characteristics, associated with six ranges of raw scores for each DISC continuum.

FIG. 7B shows potentially problematic behaviors and follow-up interview questions for candidates scoring well below or above optimal on the ‘D’ (dominance) continuum of the DISC profile.

FIG. 7C shows potentially problematic behaviors and follow-up interview questions for candidates scoring well below or above optimal on the ‘I’ (influence) continuum of the DISC profile.

FIG. 7D shows potentially problematic behaviors and follow-up interview questions for candidates scoring well below or above optimal on the ‘S’ (steadiness) continuum of the DISC profile.

FIG. 7E shows potentially problematic behaviors and follow-up interview questions for candidates scoring well below or above optimal on the ‘C’ (compliance) continuum of the DISC profile.

FIG. 8A shows PIAV characteristics, associated with three ranges of raw scores for each PIAV continuum.

FIG. 8B shows potentially problematic motivations and follow-up interview questions for candidates scoring well below or above optimal on the “Theoretical” and “Utilitarian” PIAV continua.

FIG. 8C shows potentially problematic motivations and follow-up interview questions for candidates scoring well below or above optimal on the “Aesthetic” and “Social” PIAV continua.

FIG. 8D shows potentially problematic motivations and follow-up interview questions for candidates scoring well below or above optimal on the “Individualistic” and “Traditional” PIAV continua.

### DETAILED DESCRIPTION OF THE INVENTION

### A. Introduction

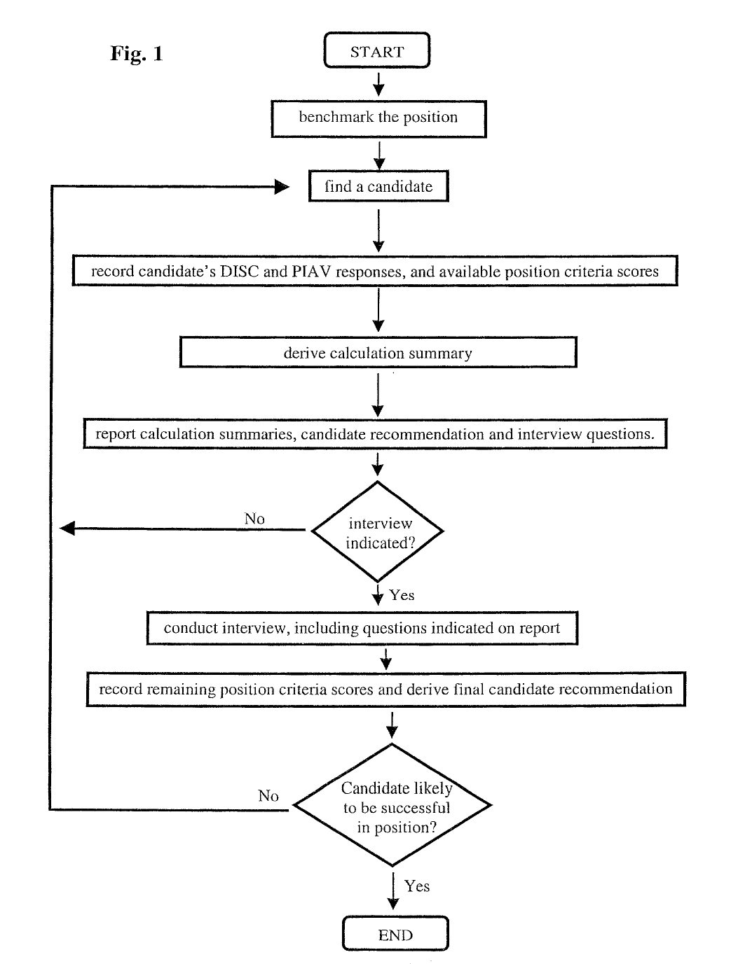

To assist in a better understanding of the invention, a specific embodiment of the present invention will now be described in detail. Although such is the preferred embodiment, it is to be understood that the invention can take other embodiments. This detailed description will include reference to FIGS. 1, 2A-2H, 3-6, 7A-7E, and 8A-8D. The same reference numerals will be used to indicate the same parts and locations in all the figures unless otherwise indicated.

The described embodiment comprises use of a computer running software that performs recordation of entered data as well as any necessary calculations as described below. Any such software, together with the computer it instructs, embodies the invented method. Such software can be developed without undue experimentation based upon the description of the method steps as provided below. Accordingly, the preferred embodiment is herein described in terms of tasks to be performed without reference to a particular software program. The presence of an adequate software program will be assumed, and referred to as “the software” or “the system.” Additionally, a system according to the present invention includes a computer display and keyboard and, preferably, a printer coupled to the computer running the software, for printing of the candidate report. The printer is not strictly necessary, however, as the report can be viewed on the computer display screen.

In sum, it is to be understood that the computer, together with the operationally-connected display screen, keyboard and printer are not required, as the invented method can be carried out by hand. The computer and operationally-connected display screen, keyboard and printer do, however, facilitate input and recordation of data, as well as computing, processing and reporting of results. The operator of the computer software embodying the invented method is referred to below, as the “user.”

To aid in understanding the invented method, it is expedient to first provide a description of the method's end-product. That end-product comprises, at a minimum, an overall Candidate Recommendation score which is preferably a number between 0 and 100 inclusive or, alternatively, a score for each of the DISC, PIAV and Positional Criteria categories that can easily be summed to an overall Candidate Recommendation score in the 0-100 range. Preferably, however, the end-product includes additional information.

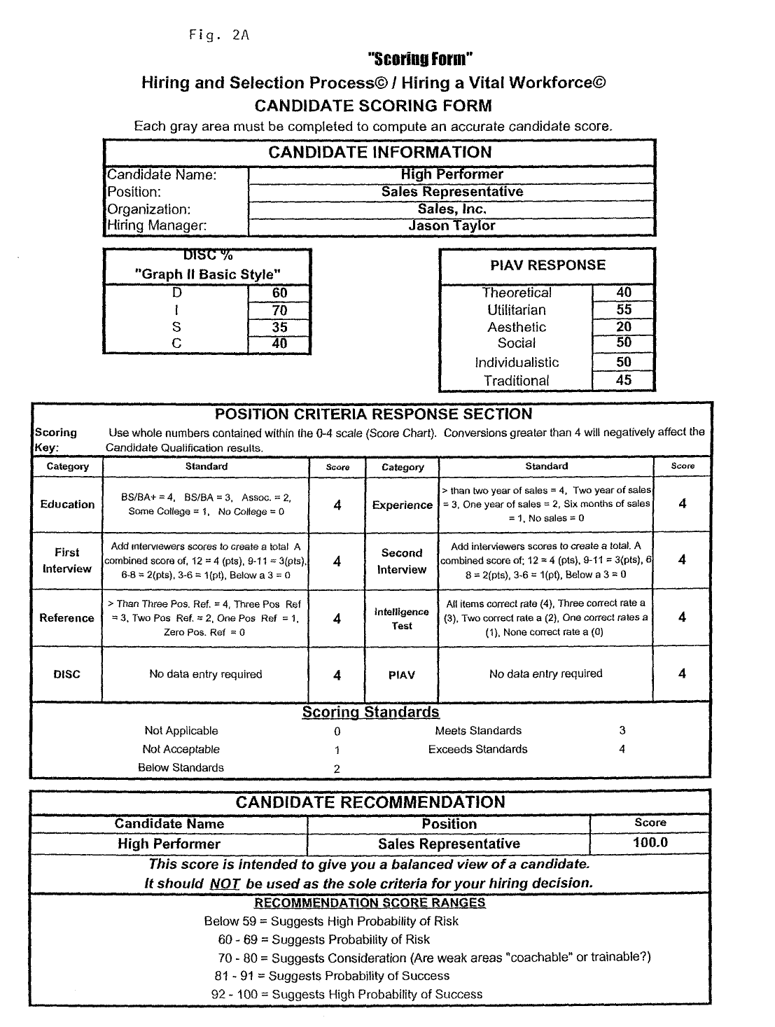

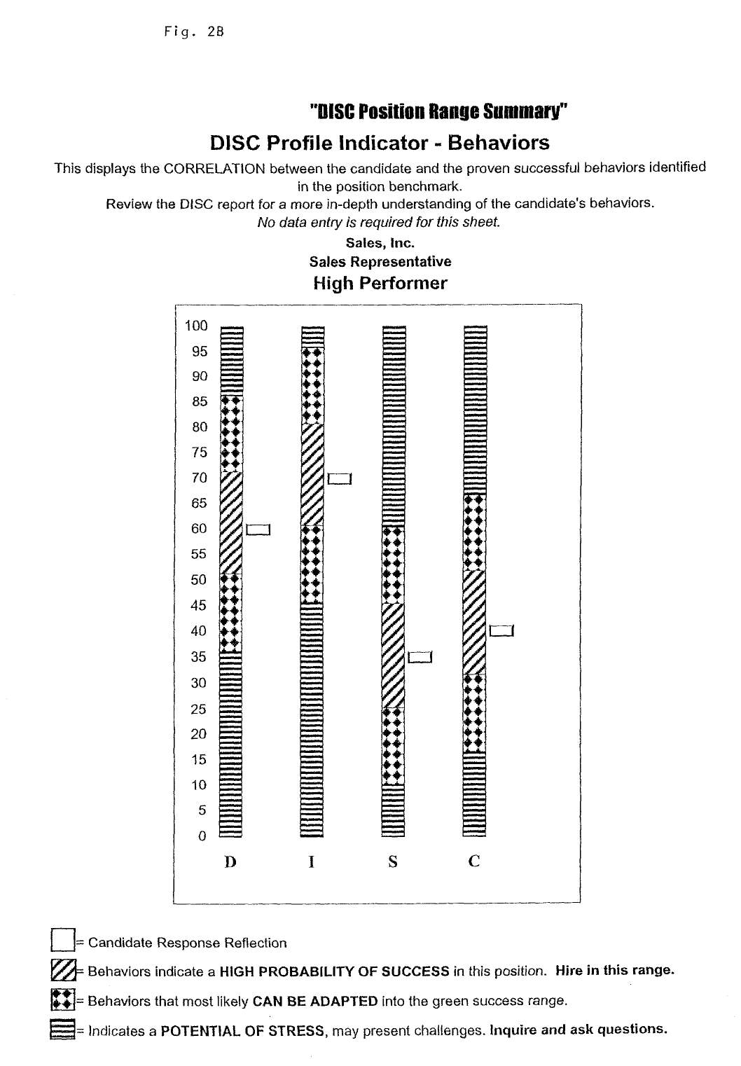

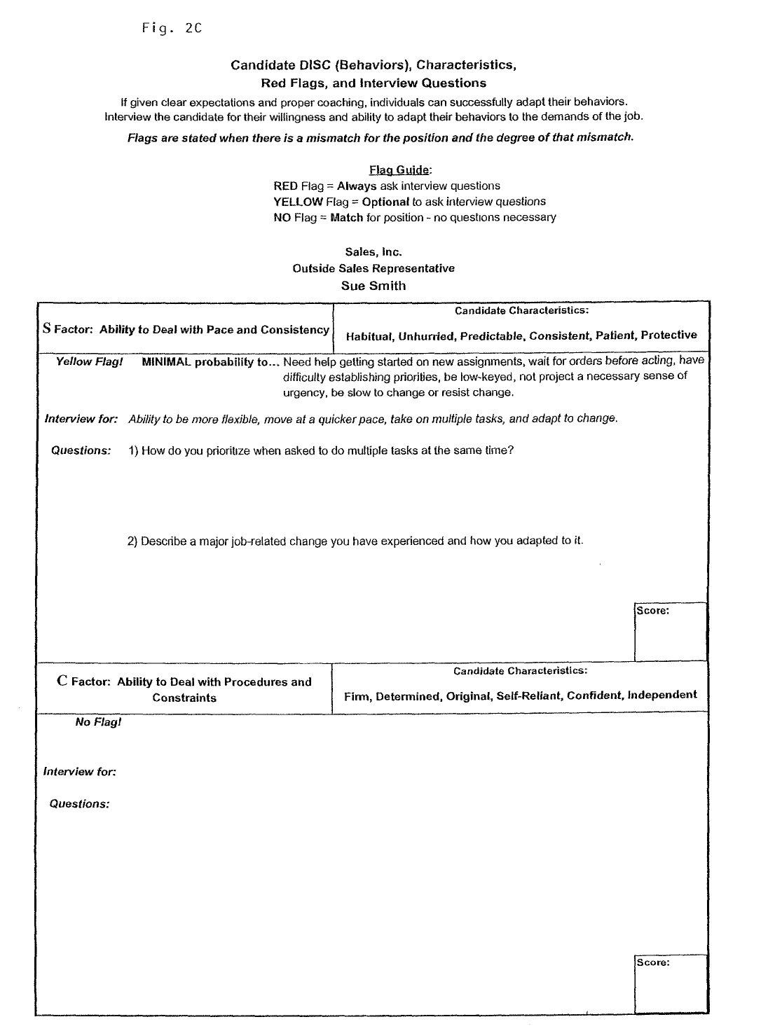

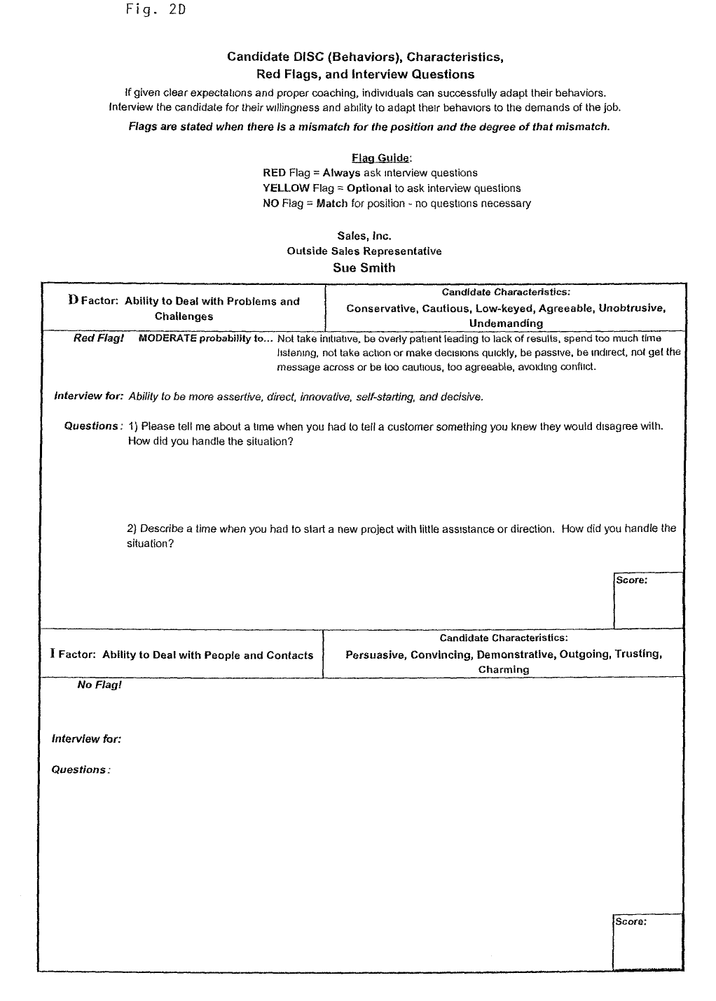

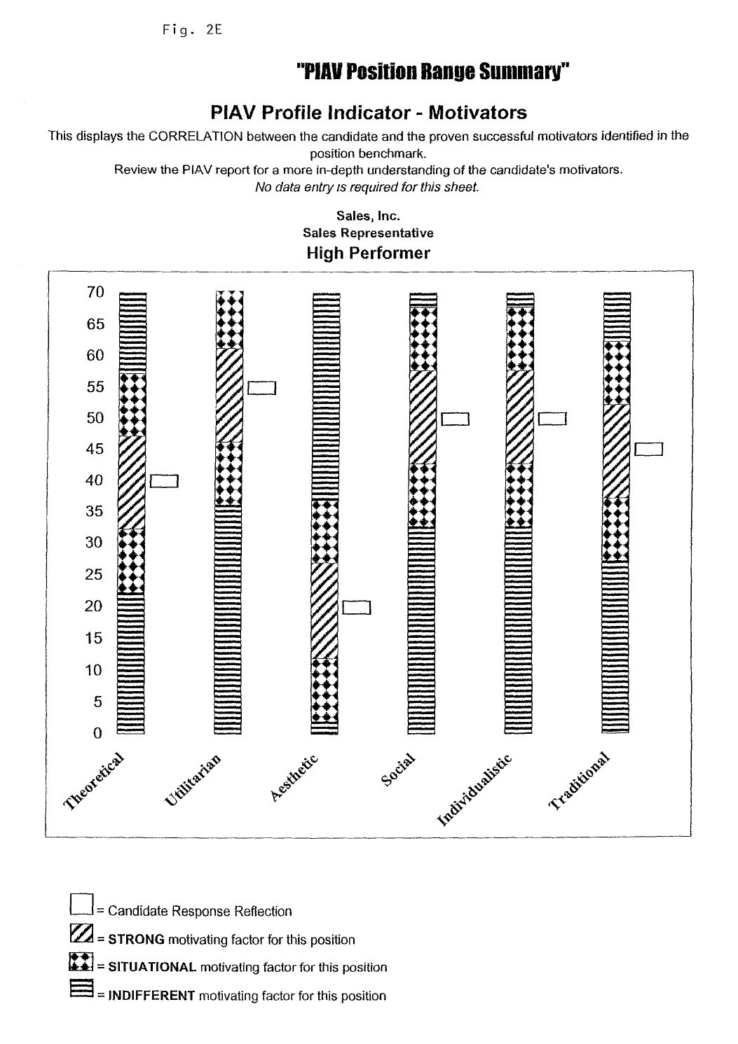

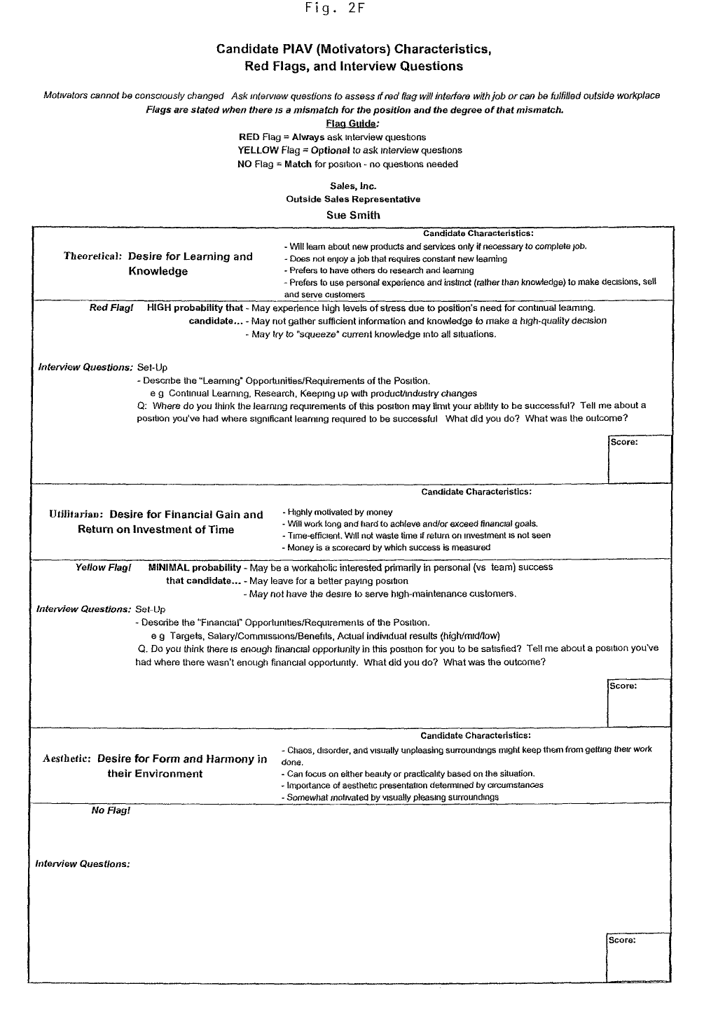

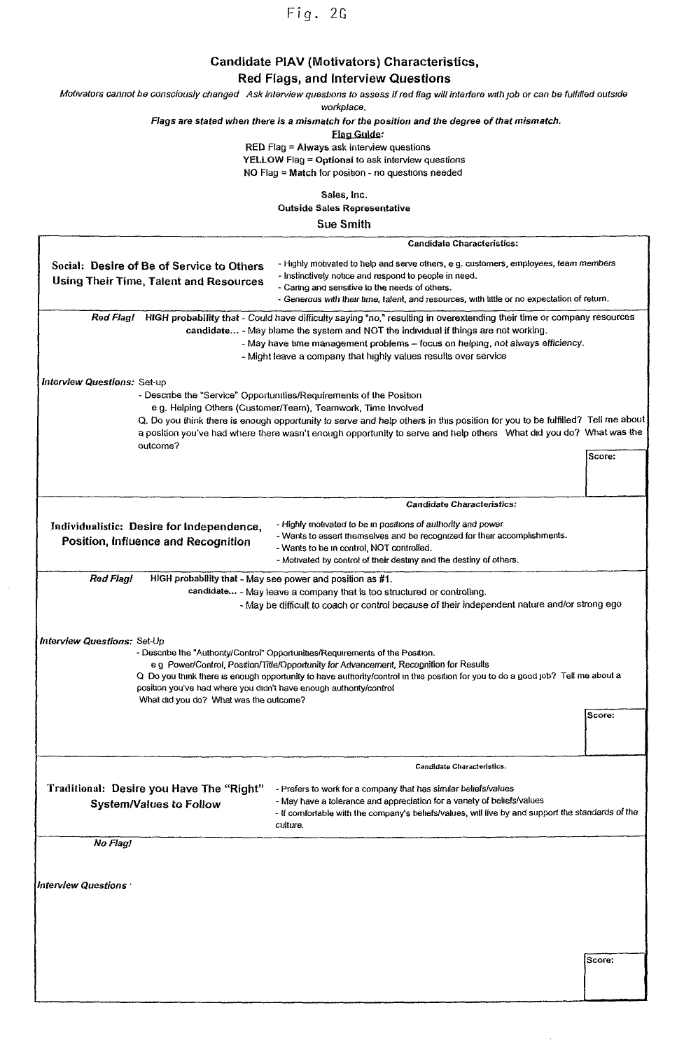

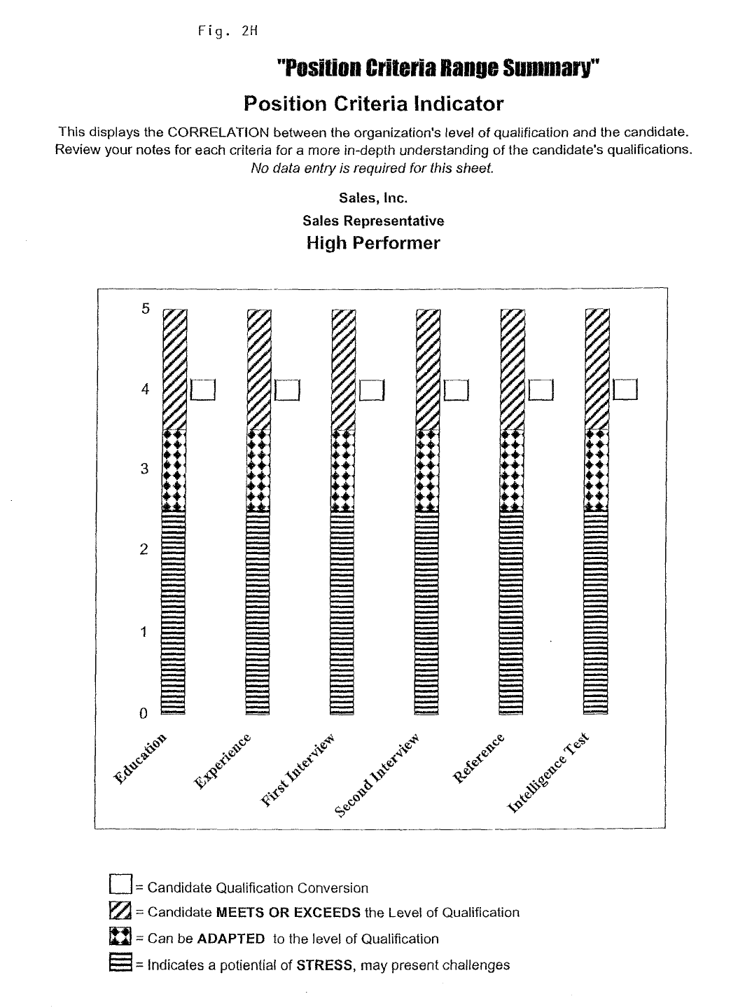

In a preferred embodiment, the end product includes a number of reported pages which collectively comprise the Candidate Report. Referring to FIG. 2A, the first page in the Candidate Report is the Candidate Scoring Form. There are five boxes of information on the Candidate Scoring Form. The first box contains the Candidate's name, the position and organization for which the Candidate is being considered, and the Hiring Manager's name. The second and third boxes contain, respectively, the Candidate's DISC and PIAV raw scores, each of which is in the 0-100 range. The fourth box contains the Candidate's scores for each Positional Criterion, each of which is in the 0-4 range, and additionally the Candidate's overall DISC and PIAV scores in the 0-4 range. The fifth box contains the overall Candidate Recommendation score, in the 0-100 range. The manner in which each of the above-referenced scores is derived is described below.

Referring to FIG. 2B, the second page of the Candidate Report contains a graphical indication of the Candidate's DISC raw scores, and how the Candidate's score in each of the D, I, S and C continua compares to the benchmark for that continuum. As described below, the benchmarking step results in the derivation of green, yellow and red zones for each DISC continuum. The Candidate's score is indicated by a small black rectangle placed next to the continuum so that it is easy to discern into which zone the Candidate's raw score for that continuum falls.

Referring to FIG. 2C-2D, the third and fourth pages of the Candidate Report contain information disclosing to the hiring manager, for each of the DISC categories—namely, D, I, S, and C—any potential problem areas as well as suggestions for interview questions. These are described in more detail in Section E, “Reporting Results,” below.

Referring to FIG. 2E, the fifth page of the Candidate Report contains a graphical indication of the Candidate's PIAV raw scores, and how the Candidate's score in each of the Th (theoretical), U (utilitarian), A (aesthetic), S (social), I (individualistic) and Tr (traditional) continua compare to the benchmark for that continuum. As described below, the benchmarking step results in the derivation of green, yellow and red zones for each PIAV continuum. Again, the Candidate's score is indicated by a small black rectangle placed next to the continuum so that it is easy to discern into which zone the Candidate's raw score for that continuum falls.

Referring to FIG. 2F-2G, the sixth and seventh pages of the Candidate Report contain information disclosing to the hiring manager, for each of the PIAV categories—namely, Th, U, A, S, I and Tr—any potential problem areas as well as suggestions for interview questions. These are described in more detail in Section E, “Reporting Results,” below.

Referring to FIG. 2H, the eighth page of the Candidate Report contains a graphical indication of the Candidate's score for each positional criterion, in the 0-4 range. As can be seen, the green zone is always at the top, the yellow zone in the middle, and the red zone at the bottom. This is because, with the positional criteria, a higher score in each such criterion is always better than a lower score. A score of 4 is always best, and a score of 0 worst.

### B. Benchmarking the position

The best performers currently performing the job and the two managers with the most knowledge about the job and its environment set the standard for measuring the candidate's probability of success. The user begins the step of benchmarking the position by entering the name of the position and the name of the organization into the computer.

Next, the user chooses the Benchmark Participants from among those persons presently performing the same or equivalent job as that for which the candidate is being considered, as follows: the user chooses the Top Performer in that position—that is, the person the user would “clone” if he could—as well as at least two other employees in that job who perform better than (or at least as well as) the other employees in that position. These individuals, collectively, are the Best Performers in the job. The user also chooses, as Benchmark Participants, those two managers who have the most knowledge about the requirements of the job and its enviromnent. Thus, the group of Benchmark Participants consists of the three Best Performers, including the Top Performer, and two managers.

### (i) Positional Criteria Settings

Next, the user determines the appropriate positional criteria for the job. The positional criteria create standards for the screening and interviewing process used to determine the relative qualification of the candidate. To ensure a balanced view of a candidate, the user preferably chooses criteria from three different categories, based upon the needs of the position. The three categories address whether the candidate (1) is qualified, (2) can produce results, and (3) is likely to be motivated to produce results. The criteria regarding candidate qualification include, without limitation: education, professional experience, skill level and testing, and product or industry knowledge. Some of these measurements can be gleaned from the candidate's resume or curriculum vitae. The criteria regarding whether the candidate can produce results include, without limitation, information gleaned from: a general behavior-based interview; a competency-based interview; a behavioral gap interview; and a telephone screen. Manifestly, these measurements of the candidate are gleaned through interviewing of the candidate. Finally, the criteria regarding whether the candidate is likely to be motivated to produce results include, without limitation, information gleaned from: a realistic job preview; drug and/or honesty testing; reference checks; background checks; and customer checks.

The user determines which positional criteria, drawn from the three above-enumerated categories, should be taken into account in evaluating the candidate's fitness for the job, and how much weight to assign to each such positional criterion. The user may obtain input from the Human Resources department, Hiring Managers, or any other individual the business organization designates.

The user then enters position standards for each chosen criterion. This entails assigning values of 0, 1, 2, 3 or 4 to measurements of the criteria, with the integers having the following meanings:

0=not acceptable

1=well below standards

2=below standards

3=meets standards

4=exceeds standards (this does not, however, indicate the candidate is overqualified, as 4 is always the best score)

The user enters into the system a description, for each chosen positional criterion, of what constitutes a score of 0, 1, 2, 3, or 4. For example, referring to FIG. 2A, in the present example, zero months experience in the same or a similar position leads to a score of ‘0’ for the “Experience” positional criterion, two or fewer months' experience results in a score of ‘1’, at least two and at most five months results in a score of ‘2’, between 5 and 6 months results in a score of ‘3’ and over six months' experience leads to a score of ‘4’.

It is not essential that the Best Performers be the source of the standards for all of the positional criteria. Indeed, unless specific types of records are kept at the organization, it may be impossible to measure the Best Performers' scores on certain of the chosen positional criteria, such as those based upon interviews and reference checks.

Next, the user assigns a percentage weight to each positional criterion such that the sum of all percentage weights is sixty percent. The reason is that the positional criteria collectively account for sixty percent of the overall Candidate Recommendation produced in the reporting step of the overall system. The user weighs each criterion in proportion to the perceived importance and relevance of that criterion in determining success in the position. Once the positional criteria and their weights are assigned, the user enters these criteria and weights into the system. The system assures that the weights sum to 60%, and if not, it displays an error message informing the user that the weights do not add up to 60%. The user must then alter or re-enter the weights such that they sum to 60%.

Referring again to FIG. 2A, an example of such assignment is as follows: Experience=10%, Sabre Skills Test=14%, Reference=5%, Education=3%, Interview #1=14%, and Interview #2=14%.

Referring to FIG. 2A, the positional criteria are measured on a scale of 0 to 4, with the following meanings: 4= exceeds standards (this does not, however, indicate the candidate is overqualified, as 4 is always the best score); 3= meets standards; 2= below standards; 1= well below standards; 0= not acceptable.

### (ii) DISC Profile Calculation

### Work Environment Profile

The next step in benchmarking the position is to create the behavioral profile benchmarks, consisting of a green zone, yellow zone and red zone for each continuum: D, I, S and C. These zones are calculated based upon a so-called “Center Point” for the green zone of each continuum, which represents the normative point based upon a combination of the work environment profile and the actual behavioral profile of the top performers in the position. First, the work environment is profiled, and then the behavioral characteristics of the Best Performers are profiled. Each contributes 50% in determining the Center Point of the green zone for the D, I, S, and C continua.

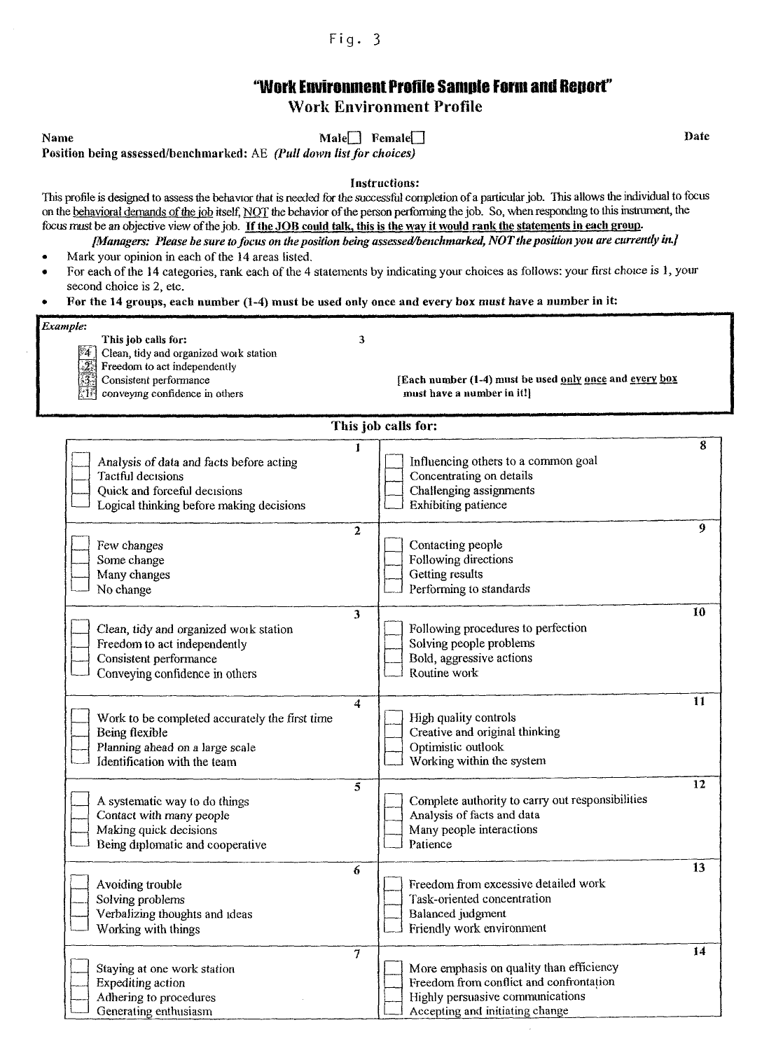

First, the user creates a work environment profile for the position. The instrument used in the creation of the work environment profile identifies general behavioral characteristics associated with success that are deemed by the Benchmark Participants to be required by the position. Referring to FIG. 3, the instrument is composed of fourteen categories based upon the DISC methodology for measuring behavioral demands of the position. The Benchmark Participants complete the instrument from the vantage point of, “If the position could speak, what would it say are the behaviors needed to be successful?” Hence, in the below claims, this instrument is referred to as the “job characteristics predictive instrument” (as contrasted with the “behavior characteristics predictive instrument”). The Benchmark Participants rank the behavioral styles within a category from 1-4, by placing a 1, 2, 3, or 4 in each box, depending upon their assessment of the type of behavioral demands of the position. The benchmark participant places a ‘1’ next to what he or she deems the most important of the four behavioral styles in that category, and a ‘4’ next to what he or she deems the least important of the four behavioral styles. Each category thus has one box with a 1, one box with a 2, one box with a 3, and one with a 4.

In each of the fourteen categories, there is one behavioral style is associated with ‘D’, one associated with ‘I’, one associated with ‘S’ and one associated with ‘C’. These letters are not visible on the questionnaire. When the questionnaire is filled out, the total raw score for each letter is computed. Because a ‘1’ indicates “most important,” it is assigned 4 points; conversely, a ‘4’ is assigned only 1 points, as it indicates “least important.” By interpolation, a ‘2’ is assigned 3 points and a ‘3’ is assigned 2 points.

Next, for each letter, the points associated with that letter, as assigned above, are summed to reach a raw score in the range of 14 to 56, inclusive for that letter. This is because if, for example, all the D's have a ‘4’ next to them, and are hence assigned one point each, the raw score for ‘D’ is 14, since there are 14 categories. Similarly, if all the D's have a ‘1’ next to them, the raw score for D is 4×14=56.

Next, for each letter, D, I, S, and C, a person's raw score of 14-56 is converted to a number in the range 0-100 by the following formula:

$$\frac{100 \times ( {raw}_{—} score - 14 )}{42}$$

All Benchmark Participants, i.e., the Best Performers and the two Managers, complete this instrument. The responses-when converted into a number in the 0-100 range per the above process-and their weight designations are combined to produce a Ratio Score. The system calculates a Ratio Score by multiplying the percentage weight times the (0-100) response, to distribute points accurately to each category. These points are then added to create a total point representation of the Ratio Score. The work environment Ratio Score comprises the following individual responses and their applied percentage weight:

Top Performer=30%

#2 Performer=10%

#3 Performer=10%

Manager 1=25%

Manager 2=25%

Thus, the responses are weighted in order of importance to ensure accuracy of the work environment exercise. The participant response weight is representative of the impact that person has in the position, with 50% represented by the Best Performers and fifty percent being represented by the Managers.

The varying response weights are designed to balance the decision between the view of management and employees. The varying response weights accommodate for the following possible conditions that may exist: a company's top performers are not producing at levels the managers need or know is possible in that position (this is balanced by having a “manager voice” in the work environment profiling of the position); top performers are not “natural superstars,” but have highly adapted to the demands of the position (this is balanced as well by having the “manager voice”); and managers are out of touch with the position, that is, they do not understand the job's needs (this is balanced by having the top performers have a portion of the weighting).

The user enters the Work Environment response scores on the Benchmark Data Worksheet in the table labeled “Work Environment Responses.” The system transfers these responses to the “Work Environment Calculation Worksheet.” The individual responses are multiplied by the appropriate percentage weighting to create a weighted mean score labeled “Points.” The points derived from each individual response are summed to create a total score. This is recreated for each continuum (D, I, S and C). The total score for each continuum is then utilized in the derivation of a Center Point for the green range of each continuum (hereinafter, simply “Center Point”).

### Actual Behavioral Style Analysis

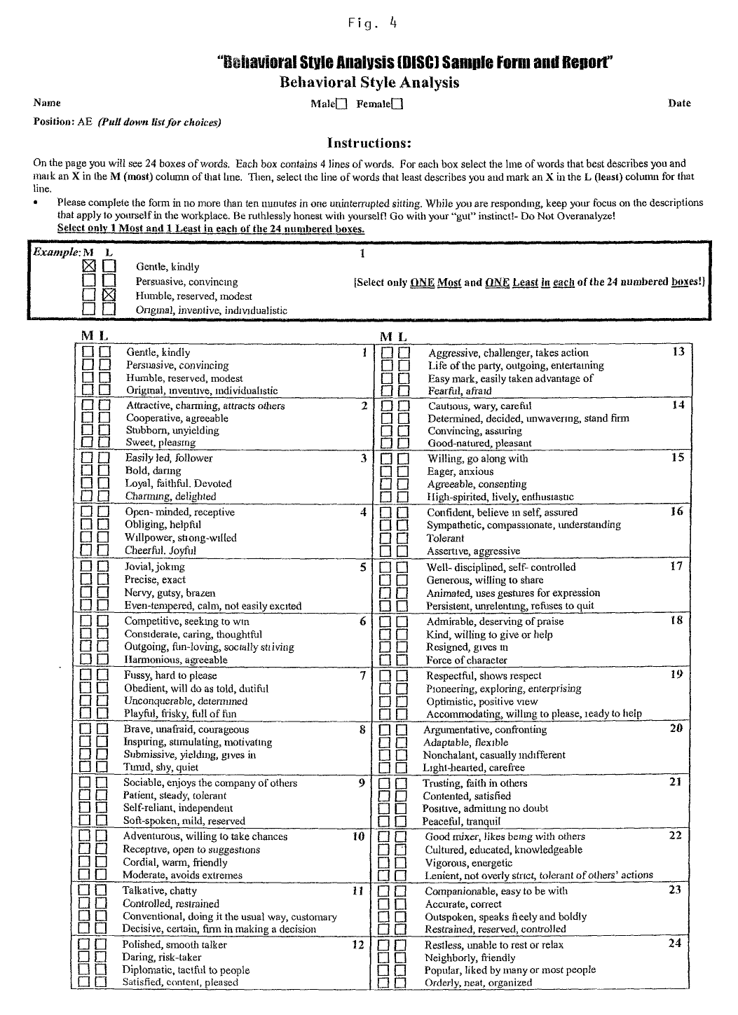

The next step in creating the behavioral profile benchmarks is to determine the actual behavioral style of the Best Performers. To accomplish this, the user utilizes an instrument based upon the DISC methodology for measuring behavioral style. Referring to FIG. 4, the instrument used in this step consists of 24 categories to be filled in with the ‘M’ and ‘L’ indicators indicating “most” and “least”. The Best Performers each complete the instrument. The answers supplied on this instrument are converted into quantitative measures for each continuum (D, I, S and C) on a scale of 0-100. The manner in which this conversion takes place is described in detail below, in the section C, “Scoring a Candidate,” in subdivision (ii), “The DISC Calculation.”

Once converted into a score in the 0-100 range, a weighted average is calculated, according to the impact the person has in the position, with the Top performer's weight being three times that of each of the other two Best Performers. This weighted average contributes 50% to the DISC Center Point. Accordingly, the DISC center point is comprised of the following responses and the applied percentage weight of the decision:

Work Environment Ratio Score=50%

Top Performer Behavioral Profile=30%

#2 Best Performer Behavioral Profile=10%

#3 Best Performer Behavioral Profile=10%

Therefore, in light of the makeup of the Work Environment Ratio score, the DISC Center Point represents the weighted average of the following scores in the 0-100 range, with assigned weights, as follows:

Work Environment Profile, according to Top Performer=15%

Work Environment Profile, according to #2 Performer=5%

Work Environment Profile, according to #3 Performer=5%

Work Environment Profile, according to Manager 1=12.5%

Work Environment Profile, according to Manager 2=12.5%

Top Performer Behavioral Profile=30%

#2 Best Performer Behavioral Profile=10%

#3 Best Performer Behavioral Profile=10%

As can be seen from the above, the participant response weight is representative of the impact that person has in the position, with half going to the Best Performers and half being represented by the Work Environment Profile responses. The weights sum to 100%.

Based upon the DISC Center Points, derived as per the above description, the DISC benchmarking step create three zones—green, yellow and red—on a linear graph for each of D, I, S and C, each scale having a range of zero to 100. Referring to FIG. 2B, ten points are added to the Center Point to create the top end of the green zone and 10 points are subtracted from the Center Point to create the bottom end of the green zone. Hence, the green zone spans 20 points total. The yellow zone is in two parts (the upper part and the lower part) of width 15 points each. The upper part has as its lower boundary the top end of the green zone, and stretches upward from there. The lower part has as its upper boundary the bottom end of the green zone, and stretches downward from there. Manifestly, the upper part is less than 15 points wide only if the green zone's upper edge is above 85. Similarly the lower part is less than 15 points wide only if the green zone's bottom edge is below 15. The red zone comprises every portion of the 0-100 range that is not either green or yellow.

### (iii) Values Profile Calculation

The final segment of benchmarking a position consists of creating values profile benchmarks. This is accomplished through use of the Personal Interests, Attitudes and Values (“PIAV”) questionnaire. The PIAV instrument identifies the intensity and magnitude of general motivational characteristics that may be categorized as personal interests, attitudes and values of individuals currently in the position being profiled. Essentially, it is a measurement of what motivates the top individuals in the position, that is, what they have a strong desire or passion for. The goal here, like with DISC, is to create a Center Point for the green zone, for each of the six continua in the PIAV profile, and then define green, yellow and red zones around that Center Point.

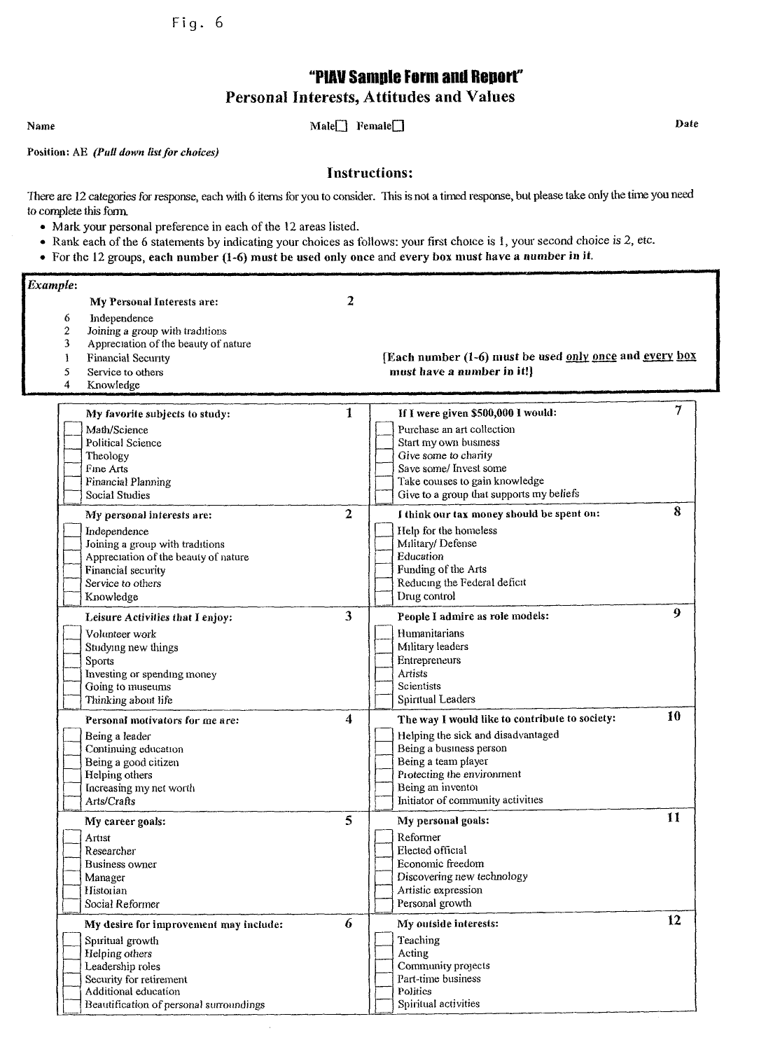

Referring to FIG. 6, The PIAV instrument contains twelve categories in which the participant is asked to assign an integer from 1 to 6 to each characteristic within a given category, depending upon how closely that characteristic describes the participant. The rankings are then used to calculate the participant's score on six continua on a scale of 10-70, as described below in Section C, “Scoring a Candidate,” subsection (iii), “The PIAV Calculation.” This process is also fully described in the Bonnstetter patent. The six continua used in the present invention are Theoretical (Th), Utilitarian (U), Aesthetic (A), Social (S), Individualistic (I), and Traditional (Tr).

The three Best Performers complete this instrument. Unlike the DISC profiling mechanism described above, there is no work environment PIAV profile contribution to the Center Point of the green zones. The Best Performers' response weight is representative of their impact in the position, with fifty percent going to the Top Performer, and fifty percent represented by the other two Best Performers:

Top Performer Values Profile=50%

#2 Best Performer Values Profile=25%

#3 Best Performer Values Profile=25%

The system maintains a linear graph numbered from 10 to 70 for each of the six motivational factors in the PIAV inventory: Th (theoretical), U (utilitarian), A (aesthetic), S (social), I (individualistic) and Tr (traditional). During the benchmarking step, the system creates three zones—green, yellow and red—on the graph for each continuum. Referring to FIG. 2E, the points derived from each individual response are summed to create the Center Point for the green zone for each characteristic. Six and one half points are added to the Center Point to create the top end of the green zone and 6.5 points are subtracted from the Center Point to create the bottom end of the green zone. Hence, the green zone spans 13 points total. The yellow zone is in two parts (and upper part and a lower part) of width 8.5 points each. The upper part has as its lower boundary the top end of the green zone, and stretches upward from there. The lower part has as its upper boundary the bottom end of the green zone, and stretches downward from there. Ordinarily, then, the green and yellow zones account for a total of 30 points, or exactly half of the 10-70 range. Manifestly, the upper part is less than 8.5 points wide only if the green zone's upper edge is above 61.5. Similarly the lower part is less than 8.5 points wide only if the green zone's bottom edge is below 18.5. The red zone comprises every portion of the 10-70 range that is not either green or yellow.

### (iv) Checking the System for Accuracy

If the invented method is automated—say, on a computer system—it is preferable to perform an integrity check before the system is put into use for the first time. Although not strictly necessary to practice the invention, performance of such a check is preferable in order to reduce the possibility of obtaining erroneous results. Notably, such check need not be performed each time a position is benchmarked; rather, it only need be performed after the actual software implementing the system is developed, but before the system is used for the first time.

The preferred method of performing such an integrity check comprise checking for a 0% grade, checking for a 25% grade, checking for a 50% grade, checking for a 75% grade and checking for a 100% grade. These checks are described below.

### Checking for a 0% Grade

To check for a 0% grade, enter four numbers into the system, one for each of D, I, S, and C, such that all four numbers are in the red zone for the respective DISC category. This should yield a “0” in the DISC segment. Cause the system to produce a DISC summary and check that it registers as “0”.

Next, enter six numbers into the system that would be in the red zone for all PIAV motivating factors. This should yield a “0” in the PIAV segment. Cause the system to produce a PIAV summary and check that it registers as “0”.

Next, enter a “0” in each positional criteria category. This should yield a “0” in the positional criteria segment. Cause the system to produce a positional criteria summary and check that it registers as “0”.

Cause the system to produce an overall Candidate score. Check that it is “0”. If it is not, the system is not working properly and the data must be re-entered to benchmark the position.

### Checking for a 25% Grade

To check for a 25% grade, enter four numbers into the system, one for each of D, I, S, and C, such that the D, I and S numbers are in the red zone, and the C number is in the green zone. This should yield a “25” in the DISC segment. Cause the system to produce a DISC summary and check that it registers as “25”. It is to be understood that, because D, I, S, and C are equally weighted, the same check can be performed by entering a number that would be in the green zone for any one of D, I, S and C and red-zone numbers for the other three continua.

Next, enter three numbers into the system that would be in the red zone for the #1 PIAV motivator (worth 30%), the #2 motivator (also worth 30%) and the #5 motivator (worth 15%). These add up to 75% of the PIAV segment; as they are all in the red zone, the result is that 75% of the PIAV score will be a “0”. Next, enter three numbers that would be in the green zone for the #3 motivator (worth 5%), the #4 motivator (also worth 5%) and the #6 motivator (worth 15%). These add up to 25% of the PIAV segment; as they are all in the green zone, the result is that 25% of the score will be a “4”. This should yield a “1” in the PIAV segment. Cause the system to produce a PIAV summary and check that it registers as “1”.

Next, enter a “1” in each positional criteria category. This should yield a “1” in the positional criteria segment. Cause the system to produce a positional criteria summary and check that the summary registers as “1”.

Cause the system to produce an overall Candidate score. It should be “25”. Check to assure that such Candidate score is “25”. If it is not, the system is not working properly and the data must be re-entered to benchmark the position.

### Checking for a 50% Grade

To check for a 50% grade, enter four numbers into the system, one for each of D, I, S, and C, such that the D and I numbers are in the red zone, and the S and C numbers are in the green zone. This should yield a “50” in the DISC segment. Cause the system to produce a DISC summary and check that it registers as “50”. It is to be understood that, because D, I, S, and C are equally weighted, the same check can be performed by entering a number that would be in the green zone for any two of D, I, S and C and red-zone numbers for the other two continua.

Next, enter three numbers into the system that would be in the red zone for the #1 PIAV motivating factor (worth 30%), the #3 motivator (worth 5%) and the #5 motivator (worth 15%). These add up to 50% of the PIAV segment; as they are all in the red zone, the result is that 50% of the PIAV score will be a “0”. Next, enter three numbers that would be in the green zone for the #2 motivator (worth 30%), the #4 motivator (worth 5%) and the #6 motivator (worth 15%). These add up to 50% of the PIAV segment; as they are all in the green zone, the result is that 50% of the PIAV score will be a “4”. This should yield a “2” in the PIAV segment. Cause the system to produce a PIAV summary and check that it registers as “2”.

Next, enter a “2” in each positional criteria category. This should yield a “2” in the positional criteria segment. Cause the system to produce a positional criteria summary and check that the summary registers as “2”.

Cause the system to produce an overall Candidate score. It should be “50”. Check to assure that such Candidate score is “50”. If it is not, the system is not working properly and the data must be re-entered to benchmark the position.

### Checking for a 75% Grade

To check for a 75% grade, enter three numbers into the system that would be in the green zone for D, I, and S. Enter one number that would be in the red zone for C. This should yield a “3” in the DISC segment. Cause the system to produce a DISC summary and check that it registers as “3”. It is to be understood that, because D, I, S, and C are equally weighted, the same check can be performed by entering a number that would be in the green zone for any three of D, I, S and C and a red-zone number for the other continuum.

Next, enter three numbers into the system that would be in the red zone for the #3 PIAV motivating factor (worth 5%), the #4 motivator (also worth 5%) and the #6 motivator (worth 15%). These add up to 25% of the PIAV segment; as they are all in the red zone, the result is that 25% of the score will be a “0”. Next, enter three numbers that would be in the green zone for the #1 motivator (worth 30%), the #2 motivator (also worth 30%) and the #5 motivator (worth 15%). These add up to 75% of the PIAV segment; as they are all in the green zone, the result is that 75% of the PIAV score will be a “4”. This should yield a “3” in the PIAV segment. Cause the system to produce a PIAV summary and check that it registers as “3”.

Next, enter a “3” in each positional criteria category. This should yield a “3” in the positional criteria segment. Cause the system to produce a positional criteria summary and check that it registers as “3”.

Cause the system to produce an overall Candidate score. It should be “75”. Check to assure that such Candidate score is “75”. If it is not, the system is not working properly and the data must be re-entered to benchmark the position.

### Checking for a 100% Grade

To check for a 100% grade, enter four numbers into the system, one for each of D, I, S, and C, such that all four numbers are in the green zone for the respective DISC category. This should yield a “4” in the DISC segment. Cause the system to produce a DISC summary and check that it registers as “4”.

Next, enter six numbers that would be in the green zone for each PIAV motivating factor. This should yield a “4” in the PIAV segment. Cause the system to produce a PIAV summary and check that it registers as “4”.

Next, enter a “4” in each positional criteria category. This should yield a “4” in the positional criteria category. Cause the system to produce a positional criteria summary and check that it registers as “4”.

Cause the system to produce an overall Candidate score. It should be “100”. Check to assure that such Candidate score is “100”. If it is not, the system is not working properly and the data must be re-entered to benchmark the position.

### (v) Securing the Integrity of the Benchmark Data

Although not strictly necessary to practice the invention, preferably access to the computer files containing the benchmark data should be password-protected to help prevent the integrity of the system from becoming compromised.

### C. Scoring a Candidate

### (i) Preliminary Steps

To score a particular employment Candidate according to the invented method, the user first enters the Candidate's name and the Hiring Manager's name. This information is reflected on the report, and is used for identification purposes.

### (ii) The DISC Calculation

The candidate's DISC calculation preferably comprises 20% of the hiring recommendation. In this step, the Candidate completes a DISC predictive instrument, with 24 categories, that is identical to the one completed by the three Best Performers during the above-described benchmarking step of “Actual Behavioral Style Analysis.” The system then measures the Candidate's responses. Measuring the Candidate's responses allows the system to generate scores in the range of 0-100 for each of D, I, S and C, as well as the overall DISC score of 0-4 reported in the Candidate Scoring Form. It additionally allows the system to derive the numerical amount that the DISC segment contributes to the Candidate Recommendation score of 0-100. The steps to perform these calculations are described below.

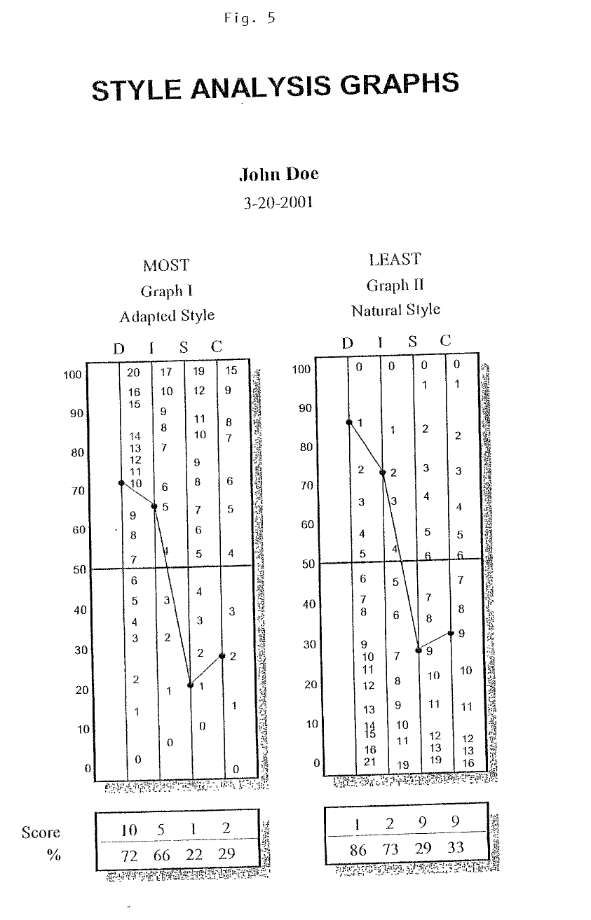

As noted, in completing the DISC questionnaire, the Candidate chooses what he or she is most like and least like in the work environment for each of the 24 response categories. Referring to FIG. 5, the responses are plotted on two graphs, Graph I representing the “most like” behavior, and Graph II representing the “least like” behavior. The vertical axis of each graph is a 0-100 scale, which is linear, i.e., each number between 0 and 100 is assigned an equal-length segment of the vertical axis. The horizontal axis is the four continua, D, I, S and C. As described in detail in the Bonnstetter patent, each box in the DISC questionnaire is assigned a letter of ‘D’, ‘I’, ‘S’, or ‘C’, or a blank. The Candidate does not see these letters-or-blank designations. (It is as if the ‘D’, ‘I’, ‘S’, ‘C’ or ‘blank’ indicator is in the box, but is invisible to the user.) The bottom of Graph I (the “Most” graph) indicates the number of boxes assigned D, I, S, and C respectively, that the Candidate indicated as “M” (most) (hereinafter, the “most-D raw score,” “most-I raw score,” “most-S raw score” and “most-C raw score,” respectively). Similarly, the bottom of Graph II (the “Least” graph) indicates the number of boxes assigned D, I, S, and C respectively, that the Candidate indicated as “L” (least) (hereinafter, the “least-D raw score,” “least-I raw score,” “least-S raw score” and “least-C raw score,” respectively). The graphs do not show the number of boxes the Candidate indicated as “M” or “L” that were assigned a blank, as such data is not needed to complete the DISC calculations.

On Graph I (the Most graph), immediately above the D, I, S and C indicators appear a set of numbers in increasing order. Note that while these numbers increase as one moves up the vertical axis, they do so at a non-linear rate, and at rates that vary from each other. Hence, a particular value on the vertical axis is associated with a most-D raw score that is different from the most-I raw score, and so on. Similarly, on Graph II (the Least graph), there is also a set of numbers immediately above the D, I, S and C indicators. As with Graph I, these numbers are not linearly spaced; unlike Graph I, however, these numbers are in decreasing order. In this way, the Candidate's indications of what he or she is least like can be plotted in a manner comparable to the Most graph, such that the higher the value on the vertical axis for D, I, S or C, the more the Candidate exhibits that behavioral style.

Referring to FIG. 5, the system plots the least-D raw score, least-I raw score, least-S raw score, and least-C raw score on Graph II. It then obtains the corresponding 0-100 value on the vertical axis for each of D, I, S and C; the “corresponding 0-100 value” is that value on the vertical axis that is horizontally directly across from where the raw score is plotted. In other words, if a horizontal line is drawn through the plotted point on the D vertical axis, the point at which such line intersects the vertical 0-100 axis to the left is the “corresponding 0-100 value” for the D continuum. Because each D, I, S and C score thus obtained is a number between 0 and 100, these scores are referred to generically as the Candidate's DISC₀₋₁₀₀ scores, or individually as the Candidates D₀₋₁₀₀, I₀₋₁₀₀, S₀₋₁₀₀ and C₀₋₁₀₀ scores.

As noted above, the system reports the Candidate's DISC₀₋₁₀₀ scores in the second box of the Candidate Scoring Form. Additionally, the system converts the DISC₀₋₁₀₀ scores into a DISC₀₋₄ score, that is a score between 0 and 4 (one such score for each continuum, i.e., a D₀₋₄, I₀₋₄, S₀₋₄ and C₀₋₄ score), using the following method. If the D₀₋₁₀₀ score is in the green zone, the D₀₋₄ score is 4; if the D₀₋₁₀₀ score is in the yellow zone, the D₀₋₄ score is 3; if the D₀₋₁₀₀ score is in the red zone, the D₀₋₄ score depends upon the difference between the D₀₋₁₀₀ score and the closest edge of the yellow zone: if that difference is less than or equal to eight and one third, the D₀₋₄ score is 2; if that difference is greater than eight and one third and less than or equal to sixteen and two thirds, the D₀₋₄ score is 1; otherwise the D₀₋₄ score is 0. The system uses the same method to calculate the I₀₋₄ score, S₀₋₄ score, and C₀₋₄ score, based upon the I₀₋₁₀₀ score, S₀₋₁₀₀ score, and C₀₋₁₀₀ score, respectively (together with the green, yellow and red zones for those continua).

Next, the system divides each of these DISC scores (between 0 and 4) by 4 to arrive at a fractional value—between 0 and 1—for each of D, I, S and C. Because each of D, I, S and C are equally weighted, the system multiplies these fractional values each by 25, and sums them. This sum is an overall DISC score of between 0 and 100, hereinafter the “overall DISC₀₋₁₀₀ score.”

The system then converts the overall DISC₀₋₁₀₀ score into a Final Correlation between the Candidate's DISC response and the profiled position scores. This Final DISC Correlation is one of the following: 0.0, 1.0, 1.5, 2.0, 2.5, 3.0, 3.5 or 4.0. The correlation is made pursuant to the following ranges for the overall DISC₀₋₁₀₀ score:

Overall DISC₀₋₁₀₀ score>=92: 4.0

Overall DISC₀₋₁₀₀ score>=83 and <92: 3.5

Overall DISC₀₋₁₀₀ score>=75 and <83: 3.0

Overall DISC₀₋₁₀₀ score>=62 and <75: 2.5

Overall DISC₀₋₁₀₀ score>=50 and <62: 2.0

Overall DISC₀₋₁₀₀ score>=37 and <50: 1.5

Overall DISC₀₋₁₀₀ score>=25 and <37: 1.0

Overall DISC₀₋₁₀₀ score>=0 and <25: 0.0

As noted above, referring to FIG. 2A, the system displays the Candidate's Final DISC Correlation on the Candidate Scoring Form at the bottom left of the fourth box. In addition, the system uses the Final DISC correlation to derive the DISC segment's contribution to the overall Candidate Recommendation score of 0-100, as follows: The system divides the Candidate's Final DISC correlation by 4.0, and then multiplies by 100X, where X is the fractional contribution that the DISC segment makes to the final Candidate Recommendation. Preferably, X=0.2, as the candidate's DISC calculation preferably comprises 20% of the hiring recommendation.

### (iii) The PIAV Calculation

The candidate's PIAV calculation preferably comprises 20% of the hiring recommendation. In this step, the Candidate completes a PIAV predictive instrument with 12 categories, as shown in FIG. 6, that is identical to the one completed by the three Best Performers during the above-described benchmarking step of “Values Profile Calculation.” The system then measures the Candidate's responses with respect to the Th (theoretical), U (utilitarian), A (aesthetic), S (social), I (individualistic) and Tr (traditional) continua. This measurement results in a score of 10-70 for each continuum, which falls into the green, yellow or red zone, for each criterion, when compared against the benchmark data. If the Candidate's score falls into the green zone on any of these six factors, that factor is deemed a strong motivational factor for the Candidate to do well in the position. If the Candidate's score falls into the yellow zone, that factor is deemed a “situational” motivating factor, meaning that the candidate will be motivated by that factor to do well in the job only in certain situations. If the Candidate's score falls into the red zone, the Candidate is deemed indifferent to that motivational factor, meaning that that factor will not provide significant motivation for the Candidate to perform well in the job To see how the system derives a score in the range 10-70 for the Candidate for each motivational factor, it is first necessary to understand that, as described in the Bonnstetter patent, each box where the user can place a 1, 2, 3, 4, 5 or 6 is associated with one of the continua. It is as if each such box contains an invisible Th, U, A, S, I or Tr. For each of the twelve categories, each of the six boxes in that category is associated with a different one of these factors, so that, for example, there will never be two A's within one category.

The Candidate completes each category by ordering the boxes 1-6 according to what motivational factors the Candidate believes are most strongly associated with him or her. A ‘1’ indicates the strongest association, while a ‘6’ indicates the weakest. For this reason, a ‘1’ is assigned six points, a ‘2’ is assigned five points, a ‘3’ is assigned four points, a ‘4’ is assigned three points, a ‘5’ is assigned two points and a ‘6’ is assigned one point. The system adds up all the points associated with the boxes associated with Th, and subtracts 2 for convenience (see below). The result is the Th raw score. The system similarly calculates raw scores for U, A, S, I and Tr. Because there are twelve categories, the lowest possible raw score for a motivational factor is (12×1)−2=10, and the highest is (12×6)−2=70. Referring to FIG. 2A, the system preferably displays these raw scores in the third box of the Candidate Scoring Form.

The system then converts the PIAV raw score for each motivational factor into a PIAV₀₋₄ score, that is, a score between 0 and 4, for that factor by using the following method: If the PIAV raw score for a given factor is in the green zone, the PIAV₀₋₄ score for that factor is 4; if the PIAV raw score for a given factor is in the yellow zone, the PIAV₀₋₄ score for that factor is 3; if the PIAV raw score for a given factor is in the red zone, the PIAV₀₋₄ score for that factor depends upon the difference between the PIAV raw score and the closest edge of the yellow zone: if such difference is less than or equal to 5, the PIAV₀₋₄ score for that factor is 2; if the difference is greater than 5 and less than or equal to 10, the PIAV₀₋₄ score for that factor is 1; otherwise the PIAV₀₋₄ score for that factor is 0.

Next, the system divides each PIAV₀₋₄ score (one for each motivational factor) by 4 to arrive at a PIAV_{fractional} score, that is, a score between 0.0 and 1.0 for each of Th, U, A, S, I and Tr. Unlike with DISC, these continua are not equally weighted. Research shows that the top two motivating factors have the most influence on the success of a candidate in a position. The next two most influential motivating factors are numbers 3 and 6, with the least influential factors being numbers 4 and 5. Therefore, the top two factors are weighted the highest, 30% each, the third and sixth factors are weighted next-highest, 15% each, and the fourth and fifth categories each account for only 5% of the weight of the total. Accordingly, the system derives an overall score of 0-100 for the PIAV segment by multiplying the PIAV_{fractional} scores associated with the Candidate's top two motivating factors by 30, multiplying the PIAV_{fractional} scores associated with the Candidate's third-most influential motivating factor and that associated with the Candidate's least influential motivating factor each by 15, and multiplying the PIAV_{fractional} scores associated with the Candidate's fourth and fifth most influential motivating factor each by 5, and then summing the results. This sum is called the “overall PIAV₀₋₁₀₀ score” because it is a number between 0 and 100 and is a weighted average of all PIAV_{fractional} scores.

The system then converts the overall PIAV₀₋₁₀₀ score into a Final Correlation between the Candidate's PIAV response and the profiled position scores. This Final PIAV Correlation is one of the following numbers: 0.0, 1.0, 1.5, 2.0, 2.5, 3.0, 3.5 or 4.0. The correlation is made pursuant to the following ranges for the overall PIAV₀₋₁₀₀ score:

Overall PIAV₀₋₁₀₀ score>=92: 4.0

Overall PIAV₀₋₁₀₀ score>=83 and <92: 3.5

Overall PIAV₀₋₁₀₀ score>=75 and <83: 3.0

Overall PIAV₀₋₁₀₀ score>=62 and <75: 2.5

Overall PIAV₀₋₁₀₀ score>=50 and <62: 2.0

Overall PIAV₀₋₁₀₀ score>=37 and <50: 1.5

Overall PIAV₀₋₁₀₀ score>=25 and <37: 1.0

Overall PIAV₀₋₁₀₀ score>=0 and <25: 0.0

As noted above, referring to FIG. 2A, the Candidate's Final PIAV correlation is shown in the first reported page at the bottom right of the fourth box. In addition, the system uses the Final PIAV correlation to derive the PIAV segment's contribution to the overall Candidate Recommendation score of 0-100, as follows: The system divides the Candidate's Final PIAV correlation by 4.0, and then multiplies by 100Y, where Y is the fractional contribution that the PIAV segment makes to the final Candidate Recommendation. Preferably Y=0.2, as the candidate's PIAV calculation preferably comprises 20% of the hiring recommendation. It is to be understood that, preferably, X+Y=0.4, but that, in any event, X+Y may not exceed 0.5.

### (iv) The Position Criteria Calculation

The candidate's Position Criteria calculation preferably comprises 60% of the hiring recommendation. In this step, the user enters into the system the Candidate's scores, integers in the range 0-4 inclusive, for the chosen position criteria according to the standards set for each such criterion in the above step of “Positional Criteria Settings.” As noted above, referring to FIG. 2A, the Candidate's position criteria scores are shown in the first reported page in approximately the top three-quarters of the fourth box. In addition, the system uses these scores to derive the position-criteria segment's contribution to the overall Candidate Recommendation score of 0-100, as follows: The system divides each of the Candidate's criteria scores by 4, to arrive at the fractional positional criteria scores of 0-1 for each criterion. Then the system multiplies each fractional score by the weight assigned to the criterion, in terms of percentage points. These weights must all add up to 100%. So, for example, if the criterion of Experience is considered one fifth the total importance of the position criteria as a whole, it is assigned 20 percentage points, and the fractional score for Experience is multiplied by 20. The results of all such multiplications then are summed resulting in a positional criteria segment score of between 0 and 100. The positional criteria segment score is then multiplied by Z, where Z−(100(X+Y)); that is, Z is the fractional contribution that the positional criteria segment makes to the final Candidate Recommendation. As noted, preferably X+Y=0.4, and hence Z=0.6, but in any event, Z may not be less than 0.5 (as X+Y may not be greater than 0.5).

### D. Final Calculation Summary

The next step in the invented method comprises deriving the overall Candidate Recommendation score of 0-100. The system collects from the stored data in the system: (a) the DISC segment's contribution to the overall Candidate Recommendation score; (b) the PIAV segment's contribution to the overall Candidate Recommendation score, and (c) the Position Criteria's contribution to the overall Candidate Recommendation score, each calculated and scored as discussed above. The system sums these three values to arrive at the final Candidate Recommendation score of between 0 and 100.

### E. Reporting Results

Once the final score for the Candidate is completed, the system reports the results to the Hiring Manager for his or her use in determining whether to hire the candidate.

### (i) Candidate Final Score

Referring to FIG. 2A, the report contains at a minimum the Candidate's final score. Preferably, the report indicates that the candidate recommendation ranges are as follows:

Overall Candidate Recommendation score <60: Suggests High Probability of Risk

Overall Candidate Recommendation score>=60 and <70: Suggests Probability of Risk

Overall Candidate Recommendation score>=70 and <81: Suggests Consideration (are weak areas “coachable” or “trainable”?).

Overall Candidate Recommendation score>=81 and <92: Suggests Probability of Success

Overall Candidate Recommendation score>=92: Suggests High Probability of Success

If the weak areas are trainable, the Hiring Manager must further consider whether the organization has the resources and the time to train the Candidate in order to strengthen the weak areas, given the particular business demands the organization is currently facing and expects to face in the short run.

### (ii) DISC Scores

Preferably the report also shows graphically, through use of bar charts, the Candidate's scores on the four DISC and six PIAV continua, and where within the green, yellow or red zones those scores fall. In particular, after the Candidate Scoring Form, referring to FIG. 2B, the second page is preferably a DISC profile indicator, which shows, for D, I, S and C, where the Candidate's scores for each respective continuum fall relative to the benchmark participants. There is a vertical bar for each continuum, containing a green zone of height 20, a yellow zone of 15 on either side of the green zone, and the rest of the continuum comprises the red zone. A black rectangle shows which zone the Candidate's score falls into, and where it falls within that zone.

### (iii) DISC Summary Sheets

Referring to FIGS. 2C-2D, after the DISC profile indicator, preferably there is a set of DISC summary sheets; there are preferably two such sheets, the first (i.e., the third page of the report) is for D and I, while the second (i.e., the fourth page of the report) is for S and C. These sheets show, for each of the DISC behavioral characteristics, the Candidate's characteristics, as well as whether there are any red or yellow “flags” which serve to alert the hiring manager to aspects of the Candidate that constitute potential problem areas. A flag indicates a possible mismatch for the position; the flag's color—yellow or red—indicates the degree of that potential mismatch, with red being more severe than yellow. Where such a flag is raised, the DISC Summary Sheet also lists questions to be asked at a subsequent Candidate interview, if one is conducted.

The System derives the DISC Summary Sheets by considering how the Candidate's overall DISC₀₋₁₀₀ score compares to the benchmark ranges—i.e., whether the Candidate's score falls into the green, yellow or red zone. The system uses that determination to extract and display data from a database of DISC characteristics, potential problem areas and suggested interview questions. The system performs a similar process for the PIAV motivational factors. The manner in which the system generates the DISC Summary Sheets is described in detail below.

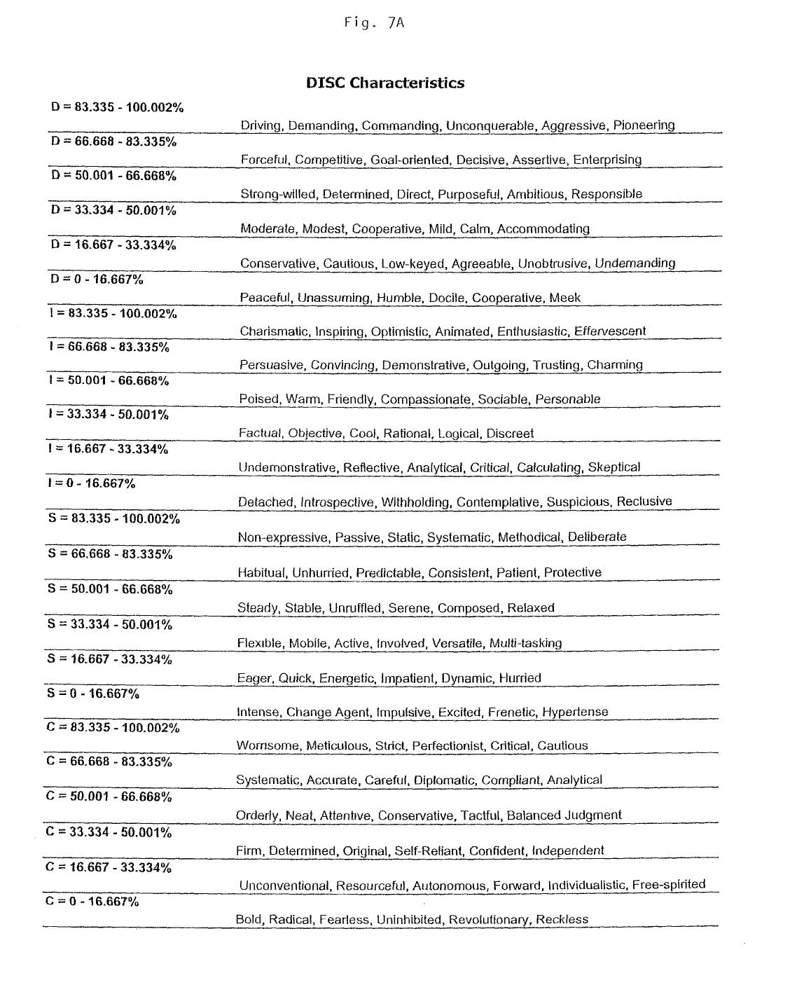

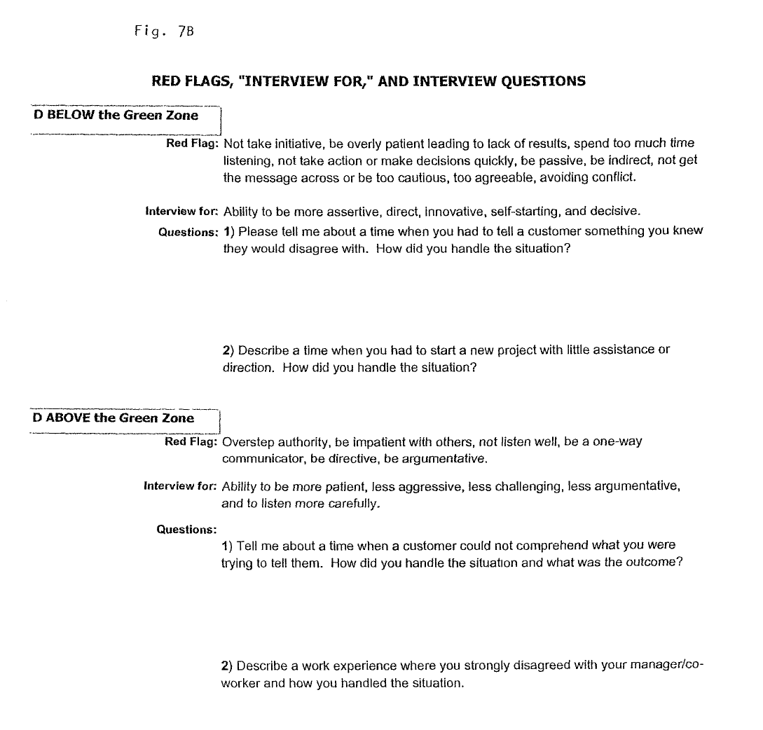

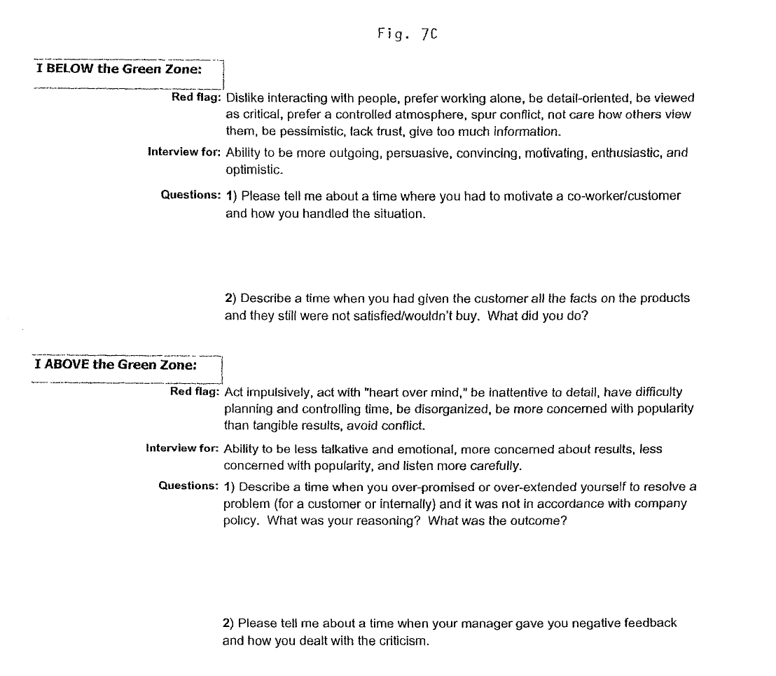

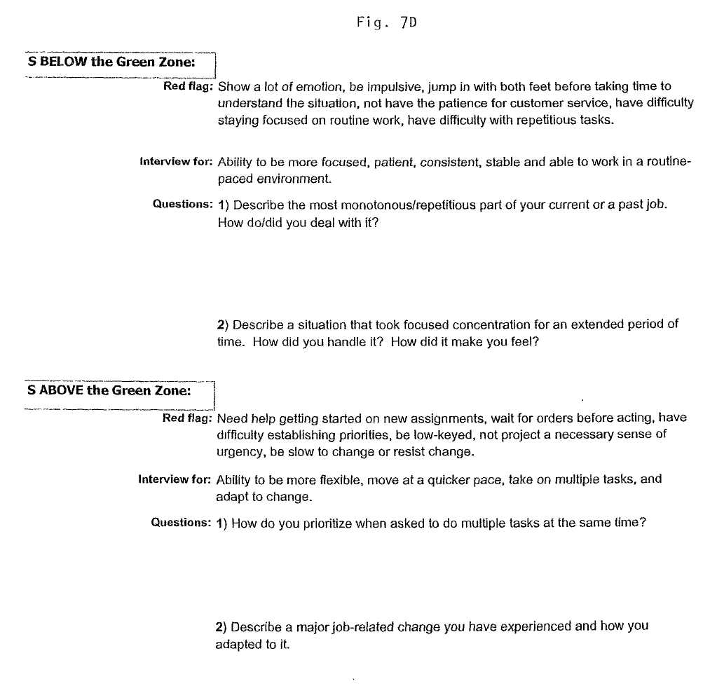

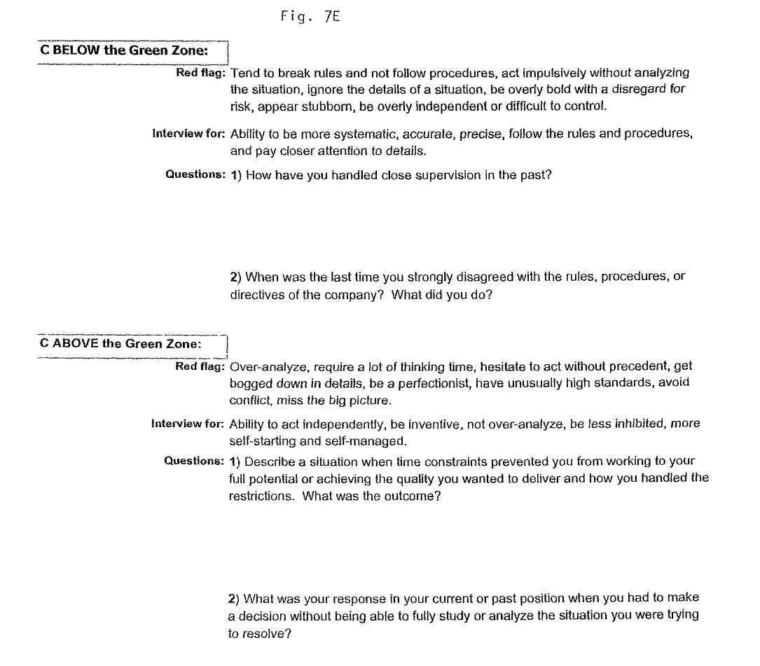

Referring to FIGS. 7A-7E, the system contains a DISC Database. As shown in FIG. 7A, the first part of this DISC database contains descriptions of characteristics associated with various ranges of scores, between 0 and 100 (inclusive), for each of the D, I, S and C continua. Each such continuum is broken down into six equal ranges, and each range is associate with certain personal characteristics or traits. For example, a D score in the range zero to sixteen-and-two-thirds is associated with the traits “Peaceful,” “Unassuming,” “Humble,” “Docile,” “Cooperative” and “Meek.”

As shown in FIGS. 7B-7E, the second part of the DISC database contains, for each of the D, I, S and C continua, two flag/follow-up data fields. These fields contain data as follows: the flag portion of the field gives the content of the warning to the hiring manager regarding the candidate's potentially problematic habits or behaviors. The follow-up portion indicates what type of improvement potential the hiring manager should interview for, and additionally contains one or more specific questions that the hiring manager should ask to that end during the interview. The reason there are two such flag/follow-up data fields is that one is triggered if the candidate's score on that continuum falls below the green zone, while the other is triggered if the score is above the green zone.

If the candidate's score is within the green zone for a particular continuum, the DISC Summary Sheet indicates “No Flag” for that continuum. If the candidate's score is in the yellow zone, the DISC Summary Sheet indicates a “Yellow Flag” for that continuum and further specifies that there is a “minimal” probability of the associated problematic behavior. In that event, the DISC Summary Sheet states that it is “optional” for the interviewer to ask the suggested interview question(s).

If the candidate's score is in the red zone, then the DISC Summary Sheet indicates a “Red Flag” for that continuum and further specifies that there is either a “moderate” or “high” probability of the associated problematic behavior: if the difference between the candidate's score and the nearest yellow zone is less than or equal to eight and one third, the DISC Summary Sheet states a “moderate” probability; otherwise it states a “high” probability. In either event, the DISC Summary Sheet states that the interviewer should “always ask” the suggested interview question(s).

Accordingly, for each of D, I, S and C, the DISC Summary Sheet includes a section providing all of the above information in an easy-to-understand format. Referring to FIG. 2C, an example is shown in which the Candidate's score falls below the green zone on the D continuum, and additionally falls in the red zone on that continuum within eight and one third points of the border with the yellow zone. The resulting section of the DISC Summary Sheet pertaining to the D factor—the “Ability to Deal with Problems and Challenges”—is illustrated in FIG. 2C.

In the upper-left-hand corner of this section of the sheet, the system displays the D factor together with its meaning. In the upper-right-hand corner, the system displays the Candidate's characteristics based upon the Candidate's overall D₀₋₁₀₀ score. Note that this is independent of the green, yellow and red ranges, and depends only upon the Candidate's numerical score on this continuum. Below that, a Red Flag is raised, showing a “moderate probability” of exhibiting the problematic behavior associated with the “below the green zone” portion of the D flag/follow-up data field of the database. The system extracts from this same portion of that data field, and displays, the improvement potential, together with the two listed questions. In this case the listed questions are mandatory, as the flag is red and hence the interviewer is directed to “always ask” the questions (see the “Flag Guide” at the top of the sheet of FIG. 2C). FIG. 2C shows the Summary Sheet sections for D and I, while FIG. 2D shows the sections for S and C.

### (iv) PIAV Scores

Referring to FIG. 2E, the fifth page of the report is preferably a PIAV profile indicator, which shows how the Candidate's behavioral motivators compare to those of the benchmark participants. For each motivator there is a vertical bar with a height of 60, ranging from 10 to 70, containing a green zone of height 13, a yellow zone of 8.5 on either side of the green zone, and the rest of the continuum comprises the red zone. Again, the Candidate's score is indicated by a black rectangle, thus showing how the candidate's score for each motivator compares with that of the benchmark participants.

### (v) PIAV Summary Sheets

Referring to FIGS. 2F-2G, after the PIAV profile indicator, preferably there is a set of PIAV summary sheets; there are preferably two such sheets, the first (i.e., the sixth page of the report) is for Th, U, and A, while the second (i.e., the seventh page of the report) is for S, I, and Tr. The PIAV Summary Sheets work in a manner similar to the DISC summary sheets. The set-up text cues the interviewer as to how to provide informational background to the Candidate prior to asking the suggested question.

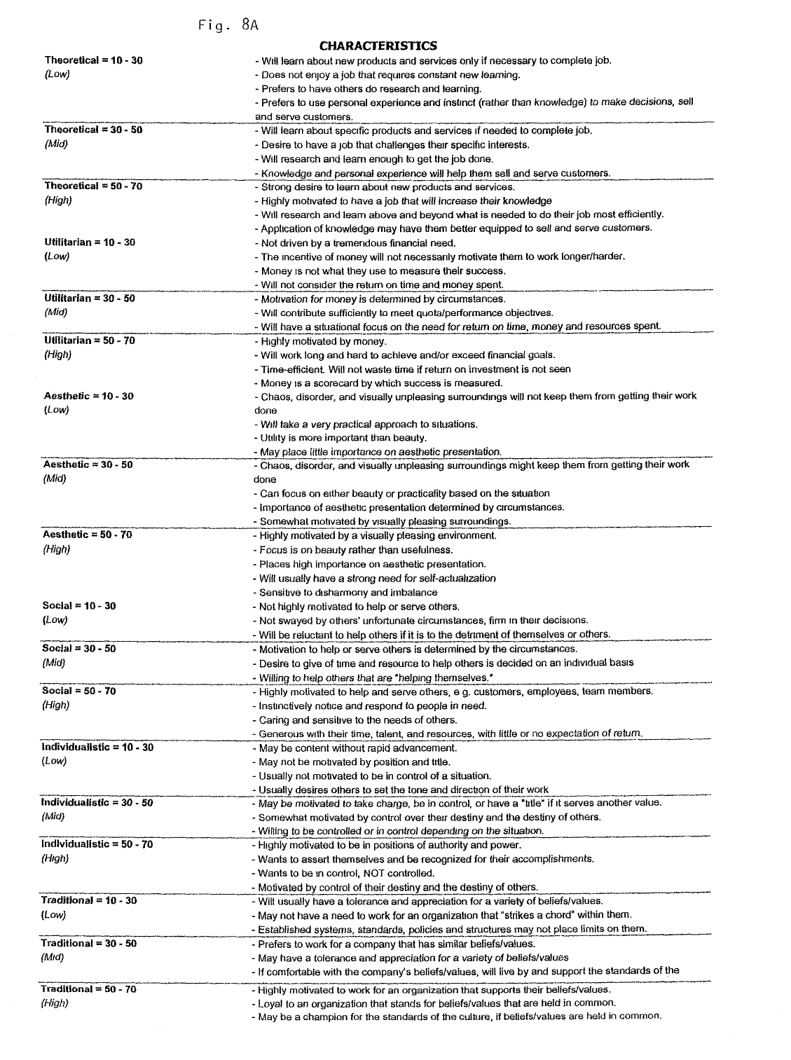

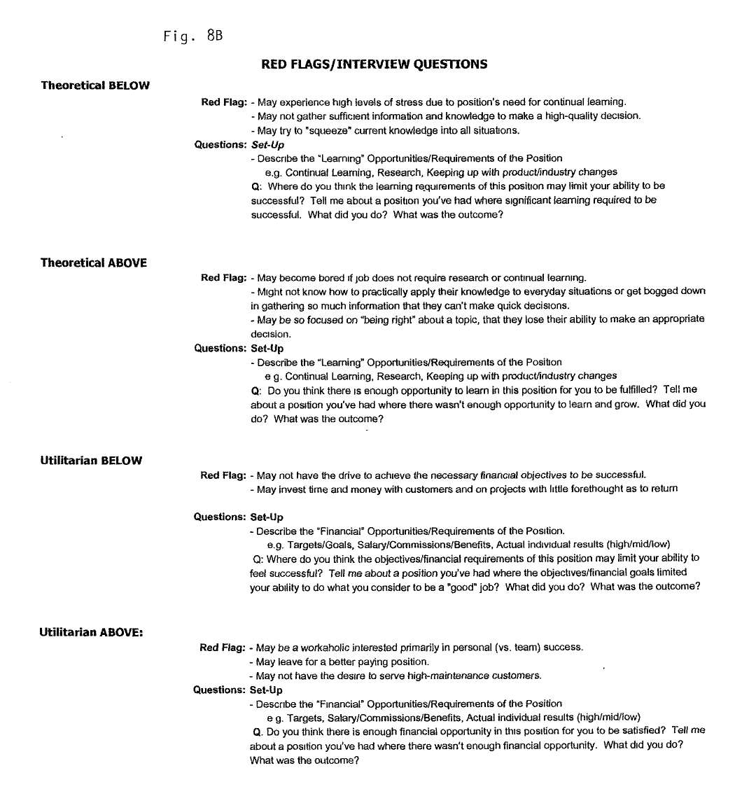

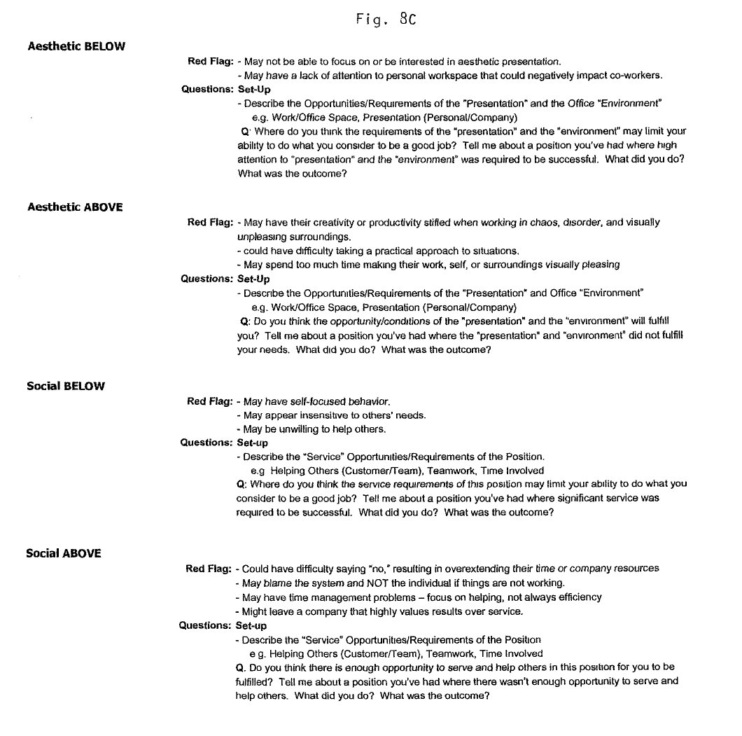

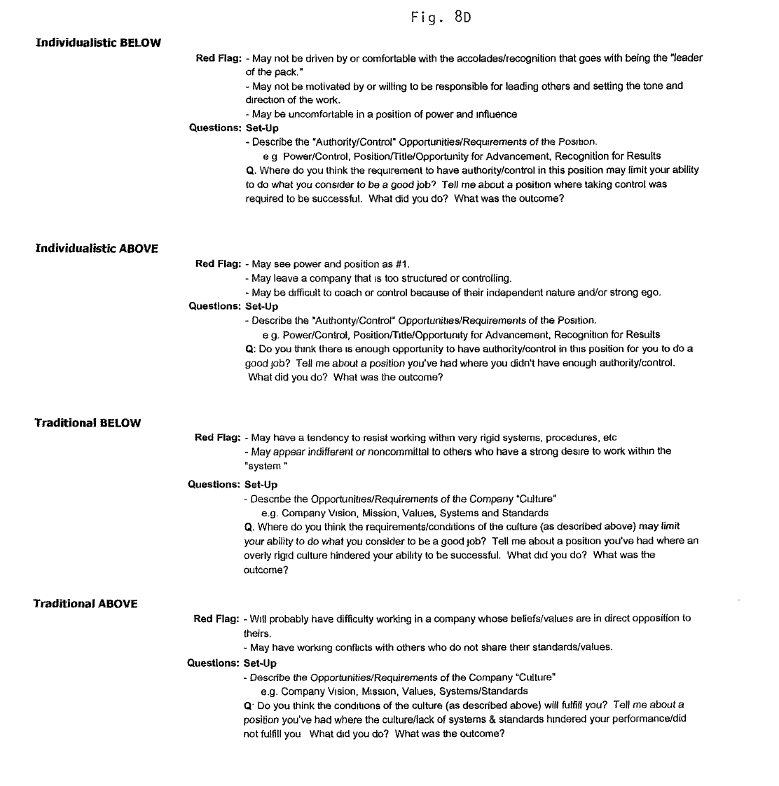

Referring to FIGS. 8A-8D, the system contains a PIAV database structured similarly to the DISC database: the first part contains descriptions of characteristics associated with various ranges of scores, between 10 and 70 (inclusive), for each of the Th, U, A, S, I and Tr continua. Each such continuum is broken down into three equal ranges, and each range is associate with certain motivational factors. For example, referring to FIG. 8A, a U score in the range 30-50 is associated with the factors, “Motivation for money is determined by circumstances,” “Will contribute sufficiently to meet quota/performance objectives,” and “Will have a situational focus on the need for return on time, money and resources spent.” The main difference between the DISC and PIAV databases is that, instead of an “interview for” portion of the flag/follow-up data field, in the PIAV database there is a “set-up” portion of such data field, as shown in FIGS. 8B-8D. Each question in the PIAV database is preceded by set-up text that the system displays on the PIAV Summary Sheet just above the suggested question(s).

FIG. 2F shows the Summary Sheet sections for Th, U, and A, while FIG. 2G shows the sections for S, I, and Tr. These sheets show data similar to that shown by the DISC summary sheets. As with the DISC continua, for each PIAV values continuum, the sheets show the Candidate's characteristics, as well as whether there are any red or yellow “flags” which serve to alert the hiring manager to aspects of the Candidate that constitute potential problem areas. A flag indicates a possible mismatch for the position; the flag's color—yellow or red—indicates the degree of that potential mismatch, with red being more severe than yellow. Where such a flag is raised, the PIAV Summary Sheet also lists questions to be asked at a subsequent Candidate interview, if one is conducted.

The System derives the PIAV Summary Sheets by considering how the Candidate's overall PIAV₀₋₁₀₀ score compares to the benchmark ranges—i.e., whether the Candidate's score falls into the green, yellow or red zone. The system uses that determination to extract and display data from a database of PIAV motivational vactors, potential problem areas and suggested interview questions. The manner in which the system generates the PIAV Summary Sheets is described in detail below.

Referring again to FIGS. 8A-8D, the system contains a PIAV Database. As shown in FIG. 8A, the first part of this PIAV database contains descriptions of characteristics associated with various ranges of scores, between 0 and 100 (inclusive), for each of the Th, U, A, S, I and Tr continua. Each such continuum is broken down into three equal ranges, and each range is associate with certain personal characteristics or traits. For example, a Th score in the range 30 to 50 is associated with the traits “will learn about specific products and services if needed to complete job,” “desire to have a job that challenges their specific interests,” “will research and learn enough to get the job done,” and “knowledge and personal experience will help them sell and serve customers.”

As shown in FIGS. 8B-8D, the second part of the PIAV database contains, for each of the Th, U, A, S, I and Tr continua, two flag/follow-up data fields. These fields contain data as follows: the flag portion of the field gives the content of the warning to the hiring manager regarding the candidate's potentially problematic values characteristics. The follow-up portion indicates one or more specific questions that the hiring manager should ask to that end during the interview, together with “set-up” content for such question(s). The reason there are two such flag/follow-up data fields is that one is triggered if the candidate's score on that continuum falls below the green zone, while the other is triggered if the score is above the green zone.

If the candidate's score is within the green zone for a particular continuum, the PIAV Summary Sheet indicates “No Flag” for that continuum. If the candidate's score is in the yellow zone, the PIAV Summary Sheet indicates a “Yellow Flag” for that continuum and further specifies that there is a “minimal” probability of the associated problematic values characteristics. In that event, the PIAV Summary Sheet states that it is “optional” for the interviewer to ask the suggested interview question(s).

If the candidate's score is in the red zone, then the PIAV Summary Sheet indicates a “Red Flag” for that continuum and further specifies that there is either a “moderate” or “high” probability of the associated problematic values characteristics: if the difference between the candidate's score and the nearest yellow zone is less than or equal to five, the PIAV Summary Sheet states a “moderate” probability; otherwise it states a “high” probability. In either event, the PIAV Summary Sheet states that the interviewer should “always ask” the suggested interview question(s).

Accordingly, for each of Th, U, A, S, I, and Tr, the PIAV Summary Sheet includes a section providing all of the above information in an easy-to-understand format. Referring to FIG. 2F, an example is shown in which the Candidate's score falls below the green zone on the Th continuum, and additionally falls in the red zone on that continuum more than five points from the border with the yellow zone. The resulting section of the PIAV Summary Sheet pertaining to the Th factor—the “Desire for Learning and Knowledge”—is illustrated in FIG. 2F.

In the upper-left-hand comer of this section of the sheet, the system displays the “Theoretical” factor together with its meaning. In the upper-right-hand comer, the system displays the Candidate's characteristics based upon the Candidate's overall Th₁₀₋₇₀ score. Note that this is independent of the green, yellow and red ranges, and depends only upon the Candidate's numerical score on this continuum. Below that, a Red Flag is raised, showing a “high probability” of having the problematic values characteristics associated with the “below the green zone” portion of the Th flag/follow-up data field of the database. The system extracts from this same portion of that data field, and displays, the listed question together with its “set-up” data. In this case the listed question is mandatory, as the flag is red and hence the interviewer is directed to “always ask” the questions (see the “Flag Guide” at the top of the sheet of FIG. 2F). FIG. 2F shows the Summary Sheet sections for Th, U and A, while FIG. 2G shows the sections for S, I and Tr.

### (vi) Positional Criteria Scores

Referring to FIG. 2H, the eighth page of the report preferably shows the Candidate's score for each position criterion. For each such criterion there is a vertical bar with a height of 4, ranging from 0 to 4. A higher score on each criterion is always better than a lower score, and hence, in this instance, the green zone is always the upper portion of the scale, the yellow zone is just below the green zone, and the red zone is always the lower portion of the scale. Again, the Candidate's score for each positional criterion is indicated by a black rectangle. With the position criteria, the green, red and yellow zones provide the hiring manager with a visual aid which allows the manager to assess the Candidate's strengths and weaknesses prior to making the hiring decision, and also allows the manager to identify the areas in which the Candidate will most likely have a particular need for post-hire training, should the Candidate be hired.

Because the determination of which colored zone the Candidate falls into relative to each position criterion is not used for further calculations, the specific placement of the border between the green and yellow zones, and the border between the yellow and red zones is not critical. Preferably, however, the green zone should occupy the portion of each positional criterion's scale from 3.5 to 4.0; the yellow zone should occupy the portion of each positional criterion's scale from 2.5 to 3.5; and the red zone should occupy the portion of each positional criterion's scale from 0 to 2.5

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of aiding a decision-maker in deciding whether to hire a candidate for an employment position, comprising:
(a) creating position criteria assessments by:
i) selecting one or more position criteria and assigning a weight to each, and
ii) assigning numerical values to measurements of each selected position criterion;
(b) creating benchmark behavioral and values characteristic assessments by:
i) selecting one or more top performers in said position and assigning a weight to each,
ii) selecting a behavior characteristic predictive instrument wherein a subject's answers to questions within it yield a raw score along at least one behavior-characteristic-continuum of possible scores indicative of a behavior characteristic,
iii) obtaining answers to said behavior characteristic predictive instrument from said one or more top performers and calculating therefrom a behavior-characteristic-raw-score along each said at least one behavior-characteristic-continuum for each top performer,
iv) deriving a behavior-characteristic-weighted-average of all behavior-characteristic-raw-scores for said at least one behavior-characteristic-continuum,
v) for each said at least one behavior-characteristic-continuum, partitioning said behavior-characteristic-continuum into at least two intervals and assigning a numerical value to each interval, such that for every pair of adjacent intervals, an interval of such pair which either includes said behavior-characteristic-weighted-average or is closer to said behavior-characteristic-weighted-average than an other interval of said pair is assigned a numerical value which is greater than that assigned to said other interval of such pair,
vi) selecting a values characteristic predictive instrument wherein a subject's answers to questions within it yield a raw score along at least one values-characteristic-continuum of possible scores indicative of a values characteristic,
vii) obtaining answers to said values characteristic predictive instrument from said one or more top performers and calculating therefrom a values-characteristic-raw-score along each said at least one values-characteristic-continuum for each top performer,
viii) deriving a values-characteristic-weighted-average of all values-characteristic-raw-scores for said at least one values-characteristic-continuum,
ix) for each said at least one values-characteristic-continuum, partitioning said values-characteristic-continuum into at least two intervals and assigning a numerical value to each interval, such that for every pair of adjacent intervals, an interval of such pair which either includes said values-characteristic-weighted-average or is closer to said values-characteristic-weighted-average than an other interval of said pair is assigned a numerical value which is greater than that assigned to said other interval of such pair;
(c) obtaining candidate-specific information by:
i) taking position criteria measurements of said candidate's strengths according to each selected position criterion,
ii) obtaining answers to said behavior characteristic predictive instrument from said candidate and calculating a raw score for said candidate along each said at least one behavior-characteristic-continuum,
iii) obtaining answers to said values characteristic predictive instrument from said candidate and calculating a raw score for said candidate along each said at least one values-characteristic-continuum;
(d) deriving candidate fitness level scores by:
i) computing as a position-criteria-fitness-level score a weighted average of numerical values assigned to said position criteria measurements,
ii) for each said at least one behavior-characteristic-continuum, assigning as a behavior-characteristic-continuum-fitness score the numerical value assigned to the interval within which said candidate's behavior-characteristic-raw-score falls,
iii) computing as a behavior-fitness-level score an average of all said behavior-characteristic-continuum-fitness scores;
iv) for each said at least one values-characteristic-continuum, assigning as a values-characteristic-continuum-fitness score the numerical value assigned to the interval within which said candidate's behavior-characteristic-raw-score falls,
v) arranging all values-characteristic-continuum-fitness scores in descending order of the behavior-characteristic-raw-score from which they were derived, and assigning a weight to each values-characteristic-continuum-fitness score based upon its position in said order, and
vi) computing as a values-fitness-level score a weighted average of all values-characteristic-continuum-fitness scores;
(e) computing an overall candidate recommendation score based upon a formula that includes said position-criteria-fitness-level score, said behavior-fitness-level score, and said values-fitness-level score as variables; and
(f) presenting to said decision-maker a report containing indicia of said overall candidate recommendation score.

2. The method of claim 1 wherein said report further comprises indicia of said candidate's raw score for each continuum of said behavior characteristic predictive instrument and said values characteristic predictive instrument, said candidate's scores for all selected position criteria, said candidate's overall behavior characteristics score, and said candidate's overall values characteristics score.

3. The method of claim 1 wherein said report further comprises, for each continuum of said behavior characteristic predictive instrument, indicia of said at least two intervals, and indicia of said candidate's raw score for said continuum.

4. The method of claim 1 wherein said report further comprises, for each continuum of said values characteristic predictive instrument, indicia of said at least two intervals, and indicia of said candidate's raw score for said continuum.

5. The method of claim 1 further comprising:
(a) providing, for each behavior characteristic predictive instrument continuum:
(i) a partitioning of said behavior characteristic predictive instrument continuum into ranges of behavior characteristic scores, a set of behavioral characteristics associated with said behavior characteristic predictive instrument continuum, and a mapping from each range of behavior characteristic scores to at least one of said set of behavioral characteristics;
(ii) a description of potentially problematic behavior by a person whose raw score for said behavior characteristic predictive instrument continuum is less than said behavior-characteristic-weighted-average for said continuum;
(iii) a description of at least one potential behavior-increasing ability for which a person, whose raw score for said behavior characteristic predictive instrument continuum is less than said behavior-characteristic-weighted-average for said continuum, can be interviewed;
(iv) at least one behavior-increase-probing question to ask a person whose raw score for said behavior characteristic predictive instrument continuum is less than said behavior-characteristic-weighted-average for said continuum, in order to interview for said at least one potential behavior-increasing ability;
(v) a description of potentially problematic behavior by a person whose raw score for said behavior characteristic predictive instrument continuum is greater than said behavior-characteristic-weighted-average for said continuum;
(vi) a description of at least one potential behavior-decreasing ability for which a person, whose raw score for said behavior characteristic predictive instrument continuum is greater than said behavior-characteristic-weighted-average for said continuum, can be interviewed; and
(vii) at least one behavior-decrease-probing question to ask a person whose raw score for said continuum is greater than said behavior-characteristic-weighted-average for said continuum, in order to interview for said at least one potential behavior-decreasing ability;
(b) providing, for each values characteristic predictive instrument continuum:
(i) a partitioning of said values characteristic predictive instrument continuum into ranges of values characteristic scores, a set of values characteristics associated with said values characteristic predictive instrument continuum, and a mapping from each range of values characteristic scores to at least one of said set of values characteristics;
(ii) a description of potentially problematic motivations by a person whose raw score for said continuum is less than said values-characteristic-weighted-average for said continuum;
(iii) at least one low-value-significance-probing question to ask a person whose raw score for said value characteristic predictive instrument continuum is less than said values-characteristic-weighted-average for said continuum;
(iv) a list of at least one opportunity type of said job whose description by an interviewer should precede an asking of said at least one low-value-significance-probing question;
(v) a description of potentially problematic motivations by a person whose raw score for said continuum is greater than said values-characteristic-weighted-average for said continuum;
(vi) at least one high-value-significance-probing question to ask a person whose raw score for said value characteristic predictive instrument continuum is greater than said values-characteristic-weighted-average for said continuum; and
(vii) a list of at least one opportunity type of said job whose description by an interviewer should precede an asking of said at least one high-value-significance-probing question.

6. The method of claim 5 wherein said report further contains a readout with:
one section for each behavior characteristic predictive instrument continuum, containing indicia of which one of said at least two intervals, said candidate's raw score for said behavior characteristic predictive instrument continuum is in; and
one section for each values characteristic predictive instrument continuum, containing indicia of which one of said at least two intervals, said candidate's raw score for said values characteristic predictive instrument continuum is in.

7. The method of claim 6 wherein:
each section of said readout pertaining to a behavior characteristic predictive instrument continuum contains indicia of said at least one of said set of behavioral characteristics to which a range, within which said candidate's raw score for said behavior characteristic predictive instrument continuum lies, is mapped; and
each section of said readout pertaining to a values characteristic predictive instrument continuum contains indicia of said at least one of said set of values characteristics to which a range, within which said candidate's raw score for said values characteristic predictive instrument continuum lies, is mapped.

8. The method of claim 6 wherein each section of said readout pertaining to a behavior characteristic predictive instrument continuum contains additional behavior information for said behavior characteristic predictive instrument continuum if said candidate's raw score for said behavior characteristic predictive instrument continuum is not in an interval containing said behavior-characteristic-weighted-average for said behavior characteristic predictive instrument continuum, and additional values information for said values characteristic predictive instrument continuum if said candidate's raw score for said values characteristic predictive instrument continuum is not in an interval containing said values-characteristic-weighted-average for said values characteristic predictive instrument continuum, wherein:
if said candidate's raw score for said behavior characteristic predictive instrument continuum is less than said behavior-characteristic-weighted-average for said behavior characteristic predictive instrument continuum, said additional behavior information comprises:
said description of potentially problematic behavior by a person whose raw score for said behavior characteristic predictive instrument continuum is less than said behavior-characteristic-weighted-average for said behavior characteristic predictive instrument continuum;
said description of at least one potential behavior-increasing ability for which a person whose raw score for said behavior characteristic predictive instrument continuum is less than said behavior-characteristic-weighted-average for said behavior characteristic predictive instrument continuum can be interviewed; and
said at least one behavior-increase-probing question to ask a person whose raw score for said behavior characteristic predictive instrument continuum is less than said behavior-characteristic-weighted-average for said behavior characteristic predictive instrument continuum; and
if said candidate's raw score for said behavior characteristic predictive instrument continuum is greater than said behavior-characteristic-weighted-average for said behavior characteristic predictive instrument continuum, said additional behavior information comprises:
said description of potentially problematic behavior by a person whose raw score for said behavior characteristic predictive instrument continuum is greater than said behavior-characteristic-weighted-average for said behavior characteristic predictive instrument continuum;
said description of at least one potential behavior-decreasing ability for which a person whose raw score for said behavior characteristic predictive instrument continuum is greater than said behavior-characteristic-weighted-average for said behavior characteristic predictive instrument continuum can be interviewed; and
said at least one behavior-decrease-probing question to ask a person whose raw score for said behavior characteristic predictive instrument continuum is greater than said behavior-characteristic-weighted-average for said behavior characteristic predictive instrument continuum; and
if said candidate's raw score for said values characteristic predictive instrument continuum is less than said values-characteristic-weighted-average for said values characteristic predictive instrument continuum, said additional values information comprises:
said description of potentially problematic motivations by a person whose raw score for said values characteristic predictive instrument continuum is less than said values-characteristic-weighted-average for said values characteristic predictive instrument continuum;
said at least one low-value-significance-probing question to ask a person whose raw score for said value characteristic predictive instrument continuum is less than said values-characteristic-weighted-average for said value characteristic predictive instrument continuum; and
said list of at least one opportunity type of said job whose description by an interviewer should precede an asking of said at least one low-value-significance-probing question; and
if said candidate's raw score for said values characteristic predictive instrument continuum is greater than said values-characteristic-weighted-average for said values characteristic predictive instrument continuum, said additional values information comprises:
said description of potentially problematic motivations by a person whose raw score for said values characteristic predictive instrument continuum is greater than said values-characteristic-weighted-average for said values characteristic predictive instrument continuum;
said at least one high-value-significance-probing question to ask a person whose raw score for said value characteristic predictive instrument continuum is greater than said values-characteristic-weighted-average for said value characteristic predictive instrument continuum; and
said list of at least one opportunity type of said job whose description by an interviewer should precede an asking of said at least one high-value-significance-probing question.

9. The method of claim 8 wherein:
said additional behavior information further comprises, if said candidate's raw score for said behavior characteristic predictive instrument continuum is in an interval adjacent to an interval containing said behavior-characteristic-weighted-average for said behavior characteristic predictive instrument continuum, indicia that there is a minimal risk that said candidate will exhibit said potentially problematic behavior; and
said additional values information further comprises, if said candidate's raw score for said values characteristic predictive instrument continuum is in an interval adjacent to an interval containing said values-characteristic-weighted-average for said values characteristic predictive instrument continuum, indicia that there is a minimal risk that said candidate will have said potentially problematic motivations.

10. The method of claim 8 wherein:
if said candidate's raw score for said behavior characteristic predictive instrument continuum is in an interval which neither contains said behavior-characteristic-weighted-average for said behavior characteristic predictive instrument continuum, nor is adjacent to an interval containing said behavior-characteristic-weighted-average for said behavior characteristic predictive instrument continuum, said additional behavior information further comprises:
if said candidate's raw score for said behavior characteristic predictive instrument continuum is less than a specified number of points away from an interval which is adjacent to an interval containing said behavior-characteristic-weighted-average for said behavior characteristic predictive instrument continuum, indicia that there is a moderate risk that said candidate will exhibit said potentially problematic behavior; and
if said candidate's raw score for said behavior characteristic predictive instrument continuum is greater than or equal to said specified number of points away from an interval which is adjacent to an interval containing said behavior-characteristic-weighted-average for said behavior characteristic predictive instrument continuum, indicia that there is a high risk that said candidate will exhibit said potentially problematic behavior; and
if said candidate's raw score for said values characteristic predictive instrument continuum is in an interval which neither contains said values-characteristic-weighted-average for said values characteristics predictive instrument continuum, nor is adjacent to an interval containing said values-characteristic-weighted-average for said values characteristic predictive instrument continuum, said additional values information further comprises:
if said candidate's raw score for said values characteristic predictive instrument continuum is less than said specified number of points away from an interval which is adjacent to an interval containing said values-characteristic-weighted-average for said values characteristic predictive instrument continuum, indicia that there is a moderate risk that said candidate will have said potentially problematic motivations; and
if said candidate's raw score for said values characteristic predictive instrument continuum is greater than or equal to said specified number of points away from an interval which is adjacent to an interval containing said values-characteristic-weighted-average for said values characteristic predictive instrument continuum, indicia that there is a high risk that said candidate will have said potentially problematic motivations.

11. The method of claim 8 wherein said readout further specifies:
where said candidate's raw score for a behavior characteristic predictive instrument continuum is in an interval which neither contains said behavior-characteristic-weighted-average for said behavior characteristic predictive instrument continuum, nor is adjacent to an interval containing said behavior-characteristic-weighted-average for said behavior characteristic predictive instrument continuum, an interviewer should ask said associated interview questions;
where said candidate's raw score for a values characteristic predictive instrument continuum is in an interval which neither contains said values-characteristic-weighted-average for said values characteristic predictive instrument continuum, nor is adjacent to an interval containing said values-characteristic-weighted-average for said values characteristic predictive instrument continuum, an interviewer should ask said associated interview questions;
where said candidate's raw score for a behavior characteristic predictive instrument continuum is in an interval which is adjacent to an interval containing said behavior-characteristic-weighted-average for said behavior characteristic predictive instrument continuum, an interviewer has discretion to ask or not ask said associated interview questions; and
where said candidate's raw score for a values characteristic predictive instrument continuum is in an interval which is adjacent to an interval containing said values-characteristic-weighted-average for said values characteristic predictive instrument continuum, an interviewer has discretion to ask or not ask said associated interview questions.
